(19) United States
(12) Patent Application Publication
(10) Pub. No.: US 2026/0225507 A1
(43) Pub. Date: Aug. 6, 2026

(54) VEHICLE SEAT

(71) Applicant: TS TECH CO., LTD., Asaka-shi, Saitama (JP)

(72) Inventors: Yu ISHII, Tochigi (JP); Tomoyuki KURIMOTO, Tochigi (JP)

(21) Appl. No.: 19/167,660

(22) PCT Filed: Jun. 20, 2024
(86) PCT No.: PCT/JP2024/022441

§ 371 Date: Sep. 22, 2025

Related U.S. Application Data
(60) Provisional application No. 63/509,375, filed on Jun. 21, 2023.
(60) Provisional application No. 63/514,225, filed on Jul. 18, 2023.

(30) Foreign Application Priority Data
Oct. 2, 2023 (JP) 2023-171498
Oct. 2, 2023 (JP) 2023-171499
Jun. 19, 2024 (JP) 2024-098939

(51) Int. Cl. B60N 2/72; B60R 21/207

(52) U.S. Cl. CPC B60N 2/72; B60R 21/207

(57) ABSTRACT

A vehicle seat includes a frame; a pad material disposed on the frame; a skin covering the pad material; and an engaging member for pulling the skin into the pad material-(The engaging member is a hook-and-loop fastener, and includes an engaging portion provided on the skin, and an engaged portion provided on the pad material and engaged with the engaging portion. A long groove portion for pulling in the skin is formed in the pad material-An attachment surface for attaching the engaged portion is formed on a bottom surface of the groove portion. At least a part of the attachment surface is inclined with respect to a perpendicular plane perpendicular to a depth direction of the groove portion.

### TECHNICAL FIELD

The present invention relates to a vehicle seat, particularly to a vehicle seat including a frame, a pad material, a skin, and an engaging member.

BACKGROUND ART Conventionally, in a vehicle seat, a technique for pulling a skin into a groove portion formed in a pad material has been known. As the pull-in method, a method in which a clip attached to the skin side is engaged with an insert wire embedded in the pad material or a method using a hook-and-loop fastener has been proposed.

For example, in a seat described in Patent Literature 1, a pattern groove portion (groove portion) is formed in a cushion material (pad material). An attachment surface for attaching a hook-and-loop fastener (engaged portion) is formed on a bottom surface of the pattern groove portion. A hook-and-loop fastener (engaging portion) is provided on a skin material (skin).

Then, the skin material is pulled into the cushion material by engaging the hook-and-loop fastener of the skin material with the hook-and-loop fastener of the pattern groove portion.

### CITATION LIST

### Patent Literature

PATENT LITERATURE 1: JP H10-272268 A

### SUMMARY OF INVENTION

### Technical Problem

In the seat described in Patent Literature 1, the attachment surface of the pattern groove portion is provided to be parallel to a perpendicular plane perpendicular to a depth direction of the groove portion. Generally, since the hook-and-loop fastener is formed from the same polyurethane material as the pad material, the hook-and-loop fastener is susceptible to thermal deformation. Therefore, the hook-and-loop fastener provided on the pad material is deformed due to heat, and the engagement force with respect to the skin decreases, which is a risk.

The present invention has been made in view of the above-described problem, and an object of the present invention is to provide a vehicle seat in which the engagement force of a skin with respect to a pad material is improved.

### SOLUTION TO PROBLEM

The above-described problem is solved by a vehicle interior skin of the present invention, the vehicle seat including: a frame; a pad material disposed on the frame; a skin covering the pad material; and an engaging member for pulling the skin into the pad material. The engaging member is a hook-and-loop fastener, and includes an engaging portion provided on the skin, and an engaged portion provided on the pad material and engaged with the engaging portion. A long groove portion for pulling in the skin is formed in the pad material. An attachment surface for attaching the engaged portion is formed on a bottom surface of the groove portion. At least a part of the attachment surface is inclined with respect to a perpendicular plane perpendicular to a depth direction of the groove portion.

With the above-described configuration, since the attachment surface is inclined, the decrease in engagement force can be suppressed even when thermal deformation occurs. Therefore, the engagement force of the skin with respect to the pad material can be improved.

In this case, it is preferable that the attachment surface is inclined from one side toward the other side in a longitudinal direction of the groove portion.

With the above-described configuration, since the attachment surface is inclined along the longitudinal direction of the groove portion, the decrease in engagement force can be further suppressed even when thermal deformation occurs.

In this case, it is preferable that the attachment surface is inclined to be symmetric about a center portion of the groove portion in the longitudinal direction.

With the above-described configuration, since a plurality the attachment surfaces having different inclination directions are formed, the decrease in engagement force can be even more suppressed even when thermal deformation occurs.

In this case, it is preferable that the attachment surface is inclined such that the groove portion is deeper at both end portions of the groove portion in the longitudinal direction than at the center portion of the groove portion.

With the above-described configuration, since a plurality of the attachment surfaces having different inclination directions are formed, the decrease in engagement force can be even more suppressed even when thermal deformation occurs.

In this case, it is preferable that the attachment surface is inclined such that the groove portion is deeper at the center portion of the groove portion in the longitudinal direction than at both end portions of the groove portion.

With the above-described configuration, since a plurality of the attachment surfaces having different inclination directions are formed, the decrease in engagement force can be even more suppressed even when thermal deformation occurs.

In this case, it is preferable that the attachment surface has a first attachment surface provided on the one side in the longitudinal direction of the groove portion, a second attachment surface provided on the other side in the longitudinal direction of the groove portion, and a third attachment surface provided between the first attachment surface and the second attachment surface in the longitudinal direction of the groove portion. It is preferable that each of the first attachment surface and the second attachment surface is inclined with respect to the perpendicular plane. It is preferable that the third attachment surface is provided to be parallel to the perpendicular plane.

With the above-described configuration, since a plurality of the inclined surfaces and the non-inclined surface are formed as the attachment surfaces, the decrease in engagement force can be even more suppressed even when thermal deformation occurs.

In this case, it is preferable that the vehicle seat further includes an airbag device attached to the frame and including an airbag and an inflator; and a locking member that is a member different from the engaging member and that is used for pulling the skin into the pad material. It is preferable that the locking member is a member other than a hook-and-loop fastener, and includes a locking portion provided on the skin, and a locked portion provided on the pad material and locked to the locking portion. It is preferable that the groove portion includes a first groove portion formed at a position corresponding to the airbag device, and a second groove portion formed at a position different from the position of the first groove portion. It is preferable that the locked portion of the locking member is provided in the first groove portion and the engaged portion of the engaging member is provided in the second groove portion.

With the above-described configuration, since a clip member having a lower engagement force than a hook-and-loop fastener is used for the first groove portion around which the airbag device is provided, the airbag is easily deployed in a desired deployment direction when the airbag is deployed.

In this case, it is preferable that the locking portion of the locking member is a hook, and it is preferable that the locked portion of the locking member is a clip that is hooked onto the hook.

With the above-described configuration, since the hook and the clip having a lower engagement force than a hook-and-loop fastener are used, the airbag is easily deployed in the desired deployment direction when the airbag is deployed.

In this case, it is preferable that the engaged portion includes an extending portion engaged with the engaging portion and extending along the longitudinal direction of the groove portion, and pad separation suppression portions that are provided at both end portions E the extending portion in a width direction and that suppress a separation of the engaged portion from the pad material.

With the above-described configuration, when the engaged portion is embedded in the pad material using insert molding, the separation of the engaged portion from the pad material can be suppressed.

In this case, it is preferable that a through-hole penetrating through each of the pad separation suppression portions in a perpendicular direction perpendicular to an extending direction and the width direction of the extending portion is formed in the pad separation suppression portion.

With the above-described configuration, when the engaged portion is embedded in the pad material using insert molding, the pad material enters the through-hole, and therefore, the separation of the engaged portion from the pad material can be further suppressed.

In this case, it is preferable that the through-hole has a triangular shape when viewed in the perpendicular direction of the extending portion.

With the above-described configuration, when the engaged portion is embedded in the pad material using insert molding, the pad material easily enters the through-hole, and therefore, the separation of the engaged portion from the pad material can be even more suppressed.

### ADVANTAGEOUS EFFECTS OF INVENTION

According to the present invention, even when thermal deformation occurs, the decrease in engagement force can be suppressed. Therefore, the engagement force of the skin with respect to the pad material can be improved.

In addition, according to the present invention, even when thermal deformation occurs, the decrease in engagement force can be further suppressed.

In addition, according to the present invention, even when thermal deformation occurs, the decrease in engagement force can be even more suppressed.

In addition, according to the present invention, when the airbag is deployed, the airbag is easily deployed in the desired deployment direction.

In addition, according to the present invention, the separation of the engaged portion from the pad material can be suppressed.

In addition, according to the present invention, the separation of the engaged portion from the pad material can be further suppressed.

In addition, according to the present invention, the separation of the engaged portion from the pad material can be even more suppressed.

### BRIEF DESCRIPTION OF DRAWINGS

FIG. 1 is a perspective view of a vehicle seat of a first embodiment.

FIG. 2 is a perspective view of a pad material.

FIG. 3 is a perspective view of an engaging member.

FIG. 4 is a partial enlarged view of an engaged portion.

FIG. 5 is a perspective view of a locking member.

FIG. 6 is a cross-sectional view taken along line VI-VI in FIG. 2, and is a view describing a groove portion.

FIG. 7 is a perspective view of an engaging member of a modification example.

FIG. 8A is a view describing a groove portion of a first modification example.

FIG. 8B is a view describing a groove portion of a second modification example.

FIG. 8C is a view describing a groove portion of a third modification example.

FIG. 8D is a view describing a groove portion of a fourth modification example.

FIG. 9 is a perspective view of a vehicle seat of a second embodiment.

FIG. 10 is a view describing a configuration of a seat back.

FIG. 11 is an exploded perspective view of a pad material of a seat cushion.

FIG. 12 is a top view of the pad material.

FIG. 13A is a view showing a state where a seat movement unit of the seat cushion is stored.

FIG. 13B is a view showing a state where the seat movement unit of the seat cushion protrudes.

FIG. 14 is a partial enlarged view of an engaging member.

FIG. 15 is a cross-sectional view of a vehicle interior skin.

FIG. 16 is a view describing materials for components of the vehicle seat.

FIG. 17 is a side view of a vehicle, and is a view showing that the mode of the vehicle is a “traveling mode (first mode) ”.

FIG. 18 is a view showing the state of the vehicle seat when the vehicle is in the “traveling mode”.

FIG. 19 is a view showing that the mode of the vehicle is a “getting in/out mode (second mode)”.

FIG. 20 is a view showing the state of the vehicle seat when the vehicle is in the “getting in/out mode”.

FIG. 21 is a view showing that the mode of the vehicle is a “rest mode (third mode)”.

FIG. 22 is a view showing the state of the vehicle seat when the vehicle is in the “rest mode”.

FIG. 23 is a diagram showing a configuration of a vehicle control device and vehicle devices.

FIG. 24 is a flowchart showing one example of the processing of a vehicle control method.

### DESCRIPTION OF EMBODIMENTS

### First Embodiment

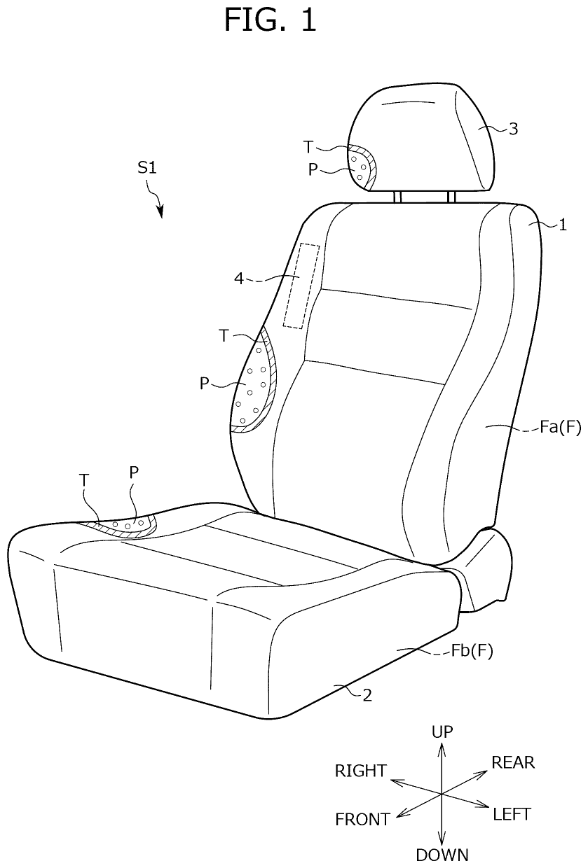

Hereinafter, an embodiment according to the present invention will be described with reference to FIGS. 1 to 8D. In the following description, the “front to rear direction” is a front to rear direction of a vehicle seat, and is a direction that coincides with a traveling direction when a vehicle travels. In addition, the “seat width direction” is a width direction of the vehicle seat, and is a direction that coincides with a right to left direction when viewed from an occupant seated in the vehicle seat. In addition, the “up to down direction” is an up to down direction of the vehicle seat, and is a direction that coincides with a vertical direction when the vehicle travels on a horizontal surface.

### Overall Configuration of Seat

As shown in FIG. 1, a vehicle seat S1 of the present embodiment is a seat which is placed on a vehicle body floor and in which the occupant of the vehicle is seated. In the present embodiment, the vehicle seat S1 is used as a front seat corresponding to a front seat of the vehicle. However, the present invention is not limited to a front seat, and the vehicle seat S1 may be a rear seat of the vehicle, and can also be used as a middle seat in a second row or a rear seat in a third row of a vehicle including three rows of seats in the front to rear direction.

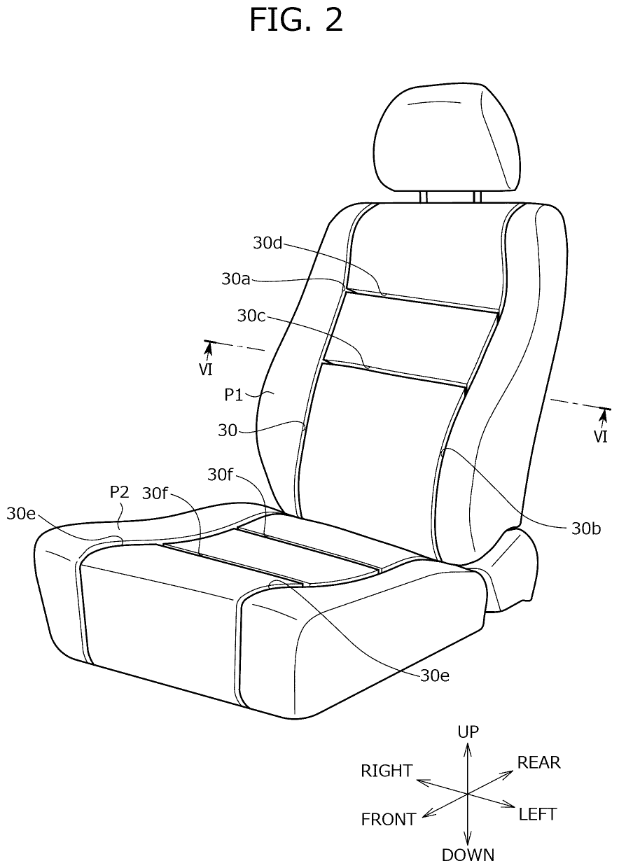

As shown in FIGS. 1 and 2, the vehicle seat S1 is mainly composed of a seat main body including a seat back 1, a seat cushion 2, and a headrest 3. A seat frame F is provided inside the vehicle seat S1. The vehicle seat S1 includes an airbag device 4 provided on the seat frame F.

In addition, the vehicle seat S1 includes a pad material P disposed on the seat frame F and a skin T that covers the pad material P.

As shown in FIGS. 1 and 2, the seat back 1 is a backrest portion that supports the back of the occupant from behind, and is configured by placing the pad material P on a back frame Fa serving as the skeleton of the seat back 1, and covering the back frame Fa and the pad material P with the skin T.

The seat cushion 2 is a seating portion that supports the occupant from below, and is configured by placing the pad material P on a cushion frame Fb serving as the skeleton of the seat cushion 2, and covering the cushion frame Fb and the pad material P with the skin T.

The headrest 3 is a head portion that supports the head of the occupant from behind, and is configured by placing the pad material P on a pillar (not shown) serving as a core material, and covering the pillar and the pad material P with the skin T.

As shown in FIG. 1, the airbag device 4 has a known configuration, is attached to the seat frame F, and includes an airbag and an inflator.

The airbag device 4 is disposed inside the seat back 1 and inside the skin T. When gas is ejected by the inflator and the airbag inflates out of a casing, the pad material P breaks along a tear line (not shown), the skin T is cut open, and the airbag is deployed outward. Incidentally, the airbag device 4 may be provided in the seat cushion 2.

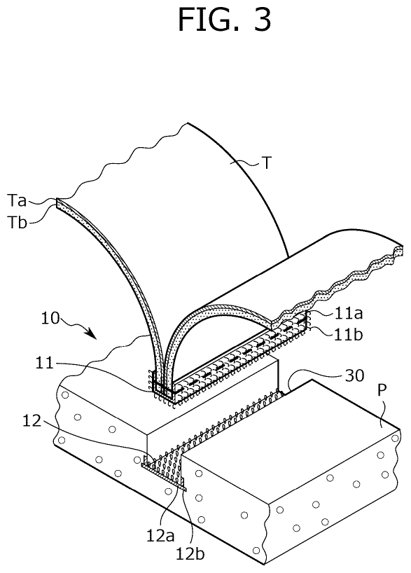

In addition, as shown in FIG. 3, the vehicle seat S1 includes an engaging member 10 for pulling the skin T into the pad material P.

The engaging member 10 is a hook-and-loop fastener having a strip shape, and includes an engaging portion 11 provided on the skin T, and an engaged portion 12 provided on the pad material P and engaged with the engaging portion 11. The skin T is fixed to the pad material P by the engaging portion 11 being engaged with the engaged portion 12 and being pulled in.

As shown in FIG. 3, the engaging portion 11 is a hook portion of a hook-and-loop fastener for pulling in the skin T. The engaging portion 11 engages with the engaged portion 12 provided on the pad material P. Incidentally, the engaging portion 11 may be a loop portion of a hook-and-loop fastener.

The engaging portion 11 is made of resin, and is formed from, for example, a polyester resin such as polyethylene terephthalate (PET). Incidentally, the engaging portion 11 may be formed from polypropylene resin, polyethylene resin, or the like.

The engaging portion 11 includes a base portion 11a attached to the skin T, and a number of hooks 11b that are provided on the base portion 11a and that engage with the engaged portion 12. The base portion 11a extends longitudinally along a pull-in end portion of the skin T, and is sewn together with the skin T.

As shown in FIG. 3, the engaged portion 12 is a loop portion for hooking the hooks 11b of the engaging portion 11. The engaged portion 12 is provided inside a groove portion 30 of the pad material P to be described later. Incidentally, the engaged portion 12 may be a hook portion of a hook-and-loop fastener.

The engaged portion 12 is made of resin, and is formed from, for example, polyurethane (PU) resin. Incidentally, the engaged portion 12 may be formed from polypropylene (PP) resin, polyacetal (POM) resin, polyamide (PA) resin, polycarbonate (PC) resin, or the like.

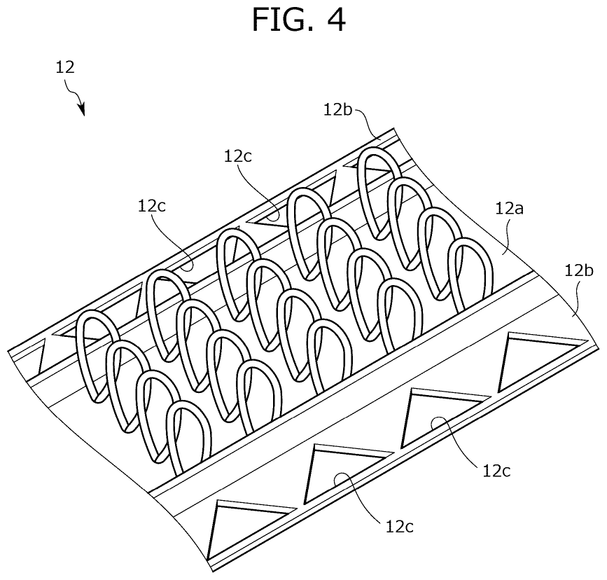

As shown in FIG. 4, the engaged portion 12 is a strip-shaped member engaged with the engaging portion 11 and extending longitudinally along the groove portion 30 of the pad material P to be described later. The engaged portion 12 includes an extending portion 12a extending along a longitudinal direction of the groove portion 30, and pad separation suppression portions 12b that are provided at both end portions of the extending portion 12a in the width direction and that suppress the separation of the engaged portion 12 from the pad material P.

As shown in FIG. 4, a number of loops that is engaged with the engaging portion 11 are provided on the extending portion 12a. Incidentally, the extending portion 12a are not limited to being provided with a number of loops, and may have any shape as long as the extending portion 12a is engaged with the hooks 11b of the engaging portion 11.

A plurality of through-holes 12c penetrating through the pad separation suppression portions 12b in a perpendicular direction perpendicular to an extending direction and the width direction of the extending portion 12a are formed in the pad separation suppression portions 12b. Each of the through-holes 12c has a triangular shape when viewed in the perpendicular direction of the extending portion 12a. Incidentally, the shape and number of the through-holes 12c are not limited thereto.

The engaged portion 12 is provided inside each of a second groove portion 30b, a third groove portion 30c, a fourth groove portion 30d, a fifth groove portion 30e, and a sixth groove portion 30f (to be described later) of the pad material P. The engaged portion 12 is integrally formed during foam molding of the pad material P, and is attached to the pad material P in a state where the pad separation suppression portions 12b is embedded in the pad material P. Incidentally, one engaged portion 12 is provided in each of the groove portions 30; however, a plurality of the engaged portions 12 may be provided in one groove portion 30 at a predetermined spacing.

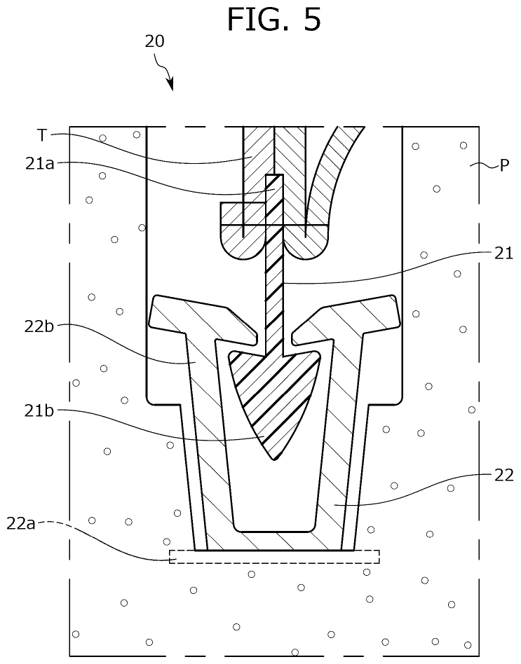

In addition, as shown in FIG. 5, the vehicle seat $1 includes a locking member 20 that is a member different from the engaging member 10 and that is used for pulling the skin T into the pad material P. The locking member 20 is, for example, a clip member, and includes a locking portion 21 provided on the skin T, and a locked portion 22 provided on the pad material P and engaged with the locking portion 21. The skin T is fixed to the pad material P by the locking portion 21 being engaged with the locked portion 22 and being pulled in.

Incidentally, the locking member 20 may be a member for locking a C-shaped hook to an insert wire embedded in the pad material P, in addition to being a clip member.

As shown in FIG. 5, the locking portion 21 is a hook, the cross-section of which is formed in an arrowhead shape at the distal end portion. The locking portion 21 is made of resin, and is formed from, for example, a polyester resin such as polyethylene terephthalate (PET).

The locking portion 21 includes a proximal end portion 21a connected to the skin T and a distal end portion 21b inserted into the locked portion 22. The proximal end portion 21a is sewn together with the skin T.

As shown in FIG. 5, the locked portion 22 is a clip that is hooked onto the locking portion 21. The locked portion 22 is made of resin, and is formed from, for example, polyurethane (PU) resin. Incidentally, the locked portion 22 may be formed from polypropylene (PP) resin, polyacetal (POM) resin, polyamide (PA) resin, polycarbonate (PC) resin, or the like.

The locked portion 22 includes a base portion 22a embedded in the pad material P and a holding portion 22b, the cross-section of which is formed in a substantially U-shape and which holds the locking portion 21. Incidentally, the cross-section of the holding portion 22b is formed in a V-shape or a C-shape.

A plurality of the locked portions 22 are provided inside a first groove portion 30a (to be described later) of the pad material P at a predetermined spacing. The locked portions 22 are attached to the pad material P in a state where the locked portions 22 are embedded in the pad material P by being integrally formed during foam molding of the pad material P.

### Skin

The skin T is made of fabric, film, cloth, leather, sheet, or the like, and is attached to cover the pad material P in a state where the skin T is stretched with a predetermined tension.

As shown in FIG. 3, the skin T includes a skin material Ta serving as a front surface and a cushion layer Tb provided on a surface on the pad material P side of the skin material Ta.

The engaging portion 11 of the engaging member 10 is provided at the pull-in end portion of the skin T. The engaging portion 11 is sewn together with the skin material Ta and the cushion layer Tb, and is attached to the pull-in end portion of the skin T. The skin T is fixed to the pad material P by the engaging portion 11 being engaged with the engaged portion 12 and being pulled in.

In such a manner, since the engaging portion 11 is sewn together with the skin material Ta and the cushion layer Tb, the separation of the engaging portion 11 from the skin T can be suppressed. Therefore, the engagement force of the skin T with respect to the pad material P can be increased.

### Pad

In the pad material P, a cushion portion is formed from a foam, and the cushion portion is covered with the skin T. As the foam, polypropylene bead foam, polyethylene bead foam, polypropylene foam, polyethylene foam, acrylonitrile-styrene foam, ethylene vinyl acetate copolymer resin, urethane foam material, or the like, or a combination thereof is used. In the present embodiment, the pad material P is a polyurethane pad molded by foam molding using a urethane foaming agent.

As shown in FIG. 2, the long groove portion 30 for pulling in the skin T is formed in the pad material P. The groove portion 30 includes the first groove portion 30a formed in a back pad P1 of the seat back 1 at a position corresponding to the airbag device 4 and extending in the up to down direction, and the second groove portion 30b formed in the back pad P1 at a position different from that of the first groove portion 30a and extending in the up to down direction.

In addition, the groove portion 30 includes the third groove portion 30c formed in a center portion of the back pad P1 in the up to down direction and extending in the seat width direction, and the fourth groove portion 30d formed above the third groove portion 30c and extending in the seat width direction.

Furthermore, the groove portion 30 includes two fifth groove portions 30e formed in a cushion pad P2 of the seat cushion 2 and extending in the front to rear direction, and two sixth groove portions 30f formed in the cushion pad P2 and extending in the seat width direction.

Incidentally, the number or disposition of the groove portions 30 is one example, and is not limited thereto.

The locked portions 22 of the locking member 20 are provided in the first groove portion 30a. In addition, the engaged portion 12 of the engaging member 10 is provided in the second groove portion 30b, the third groove portion 30c, the fourth groove portion 30d, the fifth groove portion 30e, and the sixth groove portion 30f. In such a manner, the locking member 20 (clip member) having a lower engagement force than the engaging member 10 (hook-and-loop fastener) is provided in the first groove portion 30a provided at the position corresponding to the airbag device 4. Therefore, when the airbag is deployed, the airbag is easily deployed in a desired deployment direction.

Incidentally, at least one engaging member 10 may be provided in the groove portion 30. For example, the engaged portion 12 of the engaging member 10 may be provided in the first groove portion 30a. In addition, the locked portion 22 of the locking member 20 may be provided in the second groove portion 30b, the third groove portion 30c, the fourth groove portion 30d, the fifth groove portion 30e, and the sixth groove portion 30f.

### Groove Portion

Next, the detailed structure of the groove portion 30 will be described using the third groove portion 30c as an example. Since the second groove portion 30b, the fourth groove portion 30d, the fifth groove portion 30e, and the sixth groove portion 30f have the same structure, description thereof will be omitted. Incidentally, the first groove portion 30a may also have the same configuration.

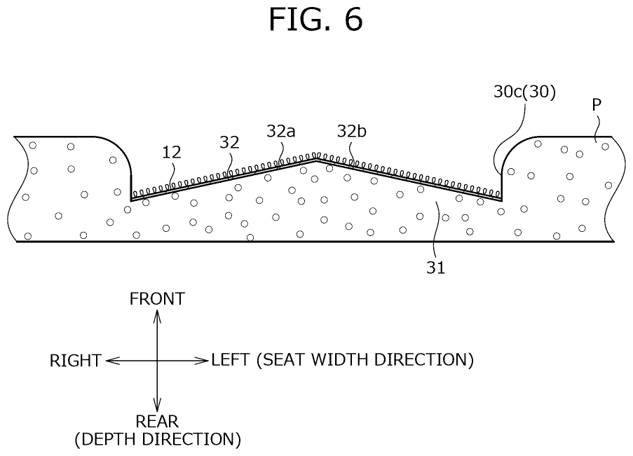

As shown in FIG. 6, an attachment portion 31 for attaching the engaged portion 12 is formed in the groove portion 30. The attachment portion 31 has an attachment surface 32 for attaching the engaged portion 12. In other words, the attachment surface 32 for attaching the engaged portion 12 is formed on a bottom surface of the groove portion 30.

The attachment portion 31 is integrally formed from the same material as the groove portion 30. Therefore, the attachment surface 32 serves as the bottom surface of the groove portion 30. However, the present invention is not limited thereto, and a configuration in which the attachment portion 31 and the groove portion 30 are formed as separate members and the attachment portion is attached to the bottom surface of the groove portion 30 may be employed.

As shown in FIG. 6, the attachment surface 32 is inclined with respect to a perpendicular plane perpendicular to a depth direction of the groove portion 30. Specifically, the attachment surface 32 is inclined from one side toward the other side in the longitudinal direction of the groove portion 30.

In detail, the attachment surface 32 has a first attachment surface 32a that is inclined upward from the right side toward the left side in the longitudinal direction (seat width direction), and a second attachment surface 32b that is inclined downward from the right side toward the left side. In other words, the attachment surface 32 is inclined such that the groove portion 30 is deeper at both end portions of the groove portion 30 in the longitudinal direction than at a center portion of the groove portion 30.

The attachment surface 32 is provided to be bilaterally symmetric about the center portion of the groove portion 30 in the longitudinal direction, and extends from the center portion toward both end portions to be inclined downward.

In such a manner, since a plurality of the attachment surfaces 32 having different inclination directions are formed in the groove portion 30, the engagement force can be even more improved.

Incidentally, in order to further improve the engagement force, the groove portion 30 extends in an inclined manner from the one side toward the other side in the longitudinal direction; however, the present invention is not limited thereto. For example, the groove portion 30 may be inclined from one side toward the other side in a width direction of the groove portion 30.

In addition, the number of the inclined attachment surfaces 32 may be one or may be three or more.

With the above-described configuration, since the attachment surface 32 to which the engaged portion 12 is attached is inclined, the engagement force of the engaging member 10 can be increased. For example, in summer, since the temperature inside a cabin becomes very high, the hook-and-loop fastener is susceptible to thermal deformation. In the present embodiment, since the attachment surface 32 is inclined, even when thermal deformation occurs in the engaging member 10, the decrease in engagement force can be further suppressed than when the attachment surface 32 is provided to be parallel to a perpendicular plane.

Therefore, the engagement force of the skin T with respect to the pad material P can be improved.

### Modification Example of Engaging Portion

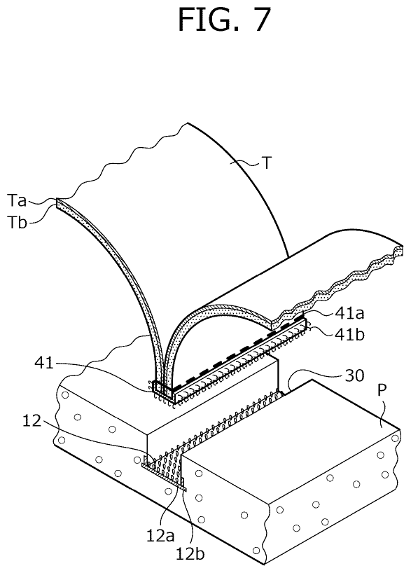

Next, a modification example of the engaging portion will be described with reference to FIG. 7. Incidentally, the description of configurations that overlap with those of the vehicle seat S1 described above will be omitted.

An engaging portion 41 of the modification example includes a base portion 41a attached to the skin T, and a number of hooks 41b that are provided on the base portion 41a and that engage with the engaged portion 12. The base portion 11a extends longitudinally along the pull-in end portion of the skin T, and is joined to the pull-in end portion using an adhesive.

In such a manner, since the engaging portion 41 is jointed to the pull-in end portion using an adhesive, the engaging portion 41 can be easily attached to the pull-in end portion of the skin T.

### Modification Example of Groove Portion

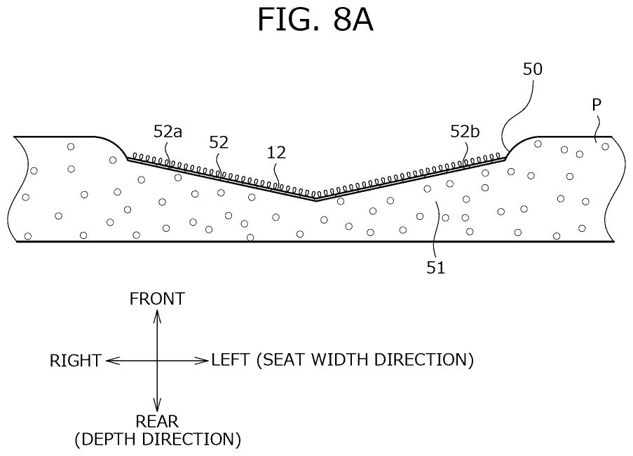

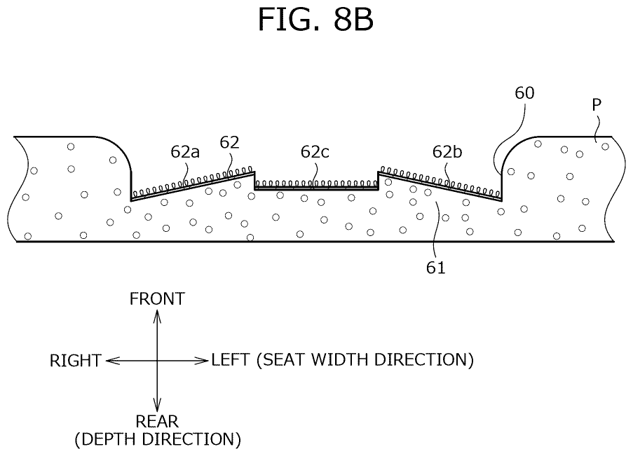

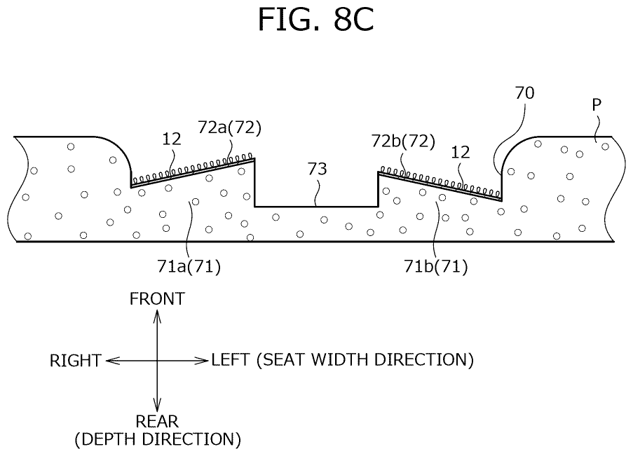

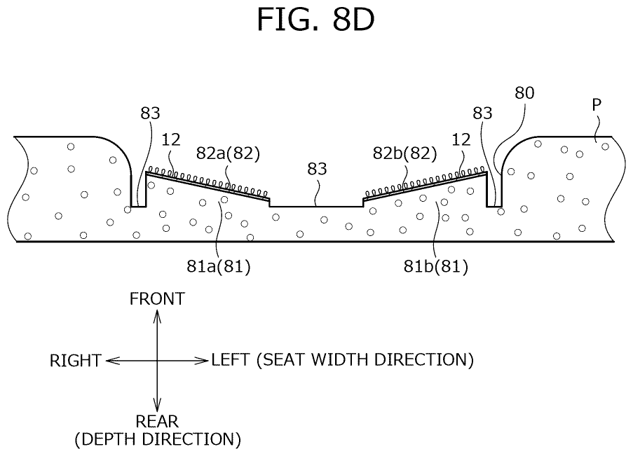

Next, Modification Examples 1 to 4 of the groove portion will be described with reference to FIGS. 8A to 8D. Incidentally, the description of configurations that overlap with those of the vehicle seat S1 described above will be omitted.

As shown in FIG. 8A, an attachment portion 51 for attaching the engaged portion 12 is formed in a groove portion 50 of the vehicle seat S1 of Modification Example 1. The attachment portion 51 has an attachment surface 52 for attaching the engaged portion 12. In other words, the attachment surface 52 for attaching the engaged portion 12 is formed on a bottom surface of the groove portion 50.

As shown in FIG. 8A, the attachment surface 52 is inclined with respect to a perpendicular plane perpendicular to a depth direction of the groove portion 50.

In detail, the groove portion 50 has a first attachment surface 52a that is inclined downward from the right side toward the left side in the longitudinal direction (seat width direction), and a second attachment surface 52b that is inclined upward from the right side toward the left side. In other words, the attachment surface 52 is inclined such that the groove portion 50 is deeper at a center portion of the groove portion 50 in the longitudinal direction than at both end portions of the groove portion 50.

The attachment surface 52 is provided to be bilaterally symmetric about the center portion of the groove portion 50 in the longitudinal direction, and extends from the center portion toward both end portions to be inclined upward.

In such a manner, since a plurality of the attachment surfaces 52 having different inclination directions are formed in the groove portion 50, the engagement force can be even more improved.

As shown in FIG. 8B, an attachment portion 61 for attaching the engaged portion 12 is formed in a groove portion 60 of the vehicle seat S1 of Modification Example 2. The attachment portion 61 has an attachment surface 62 for attaching the engaged portion 12. In other words, the attachment surface 62 for attaching the engaged portion 12 is formed on a bottom surface of the groove portion 60.

As shown in FIG. 8B, a part of the attachment surface 62 is inclined with respect to a perpendicular plane perpendicular to a depth direction of the groove portion 60. In detail, the attachment surface 62 has a first attachment surface 62a provided on one side in the longitudinal direction (the right side in the seat width direction) of the groove portion 60; a second attachment surface 62b provided on the other side in the longitudinal direction (the right side in the seat width direction) of the groove portion 60; and a third attachment surface 62c provided between the first attachment surface 62a and the second attachment surface 62b in the longitudinal direction of the groove portion 60.

Each of the first attachment surface 62a and the second attachment surface 62b is inclined with respect to the perpendicular plane. Specifically, the first attachment surface 62a is inclined upward from the right side to the left side in the longitudinal direction of the groove portion 60. The second attachment surface 62b is inclined downward from the right side to the left side in the longitudinal direction of the groove portion 60. The third attachment surface 62c is provided to be parallel to the perpendicular plane.

Incidentally, the engaged portion 12 is not attached to vertical surfaces of the groove portion 60 extending in the depth direction; however, the engaged portion 12 may be attached to the vertical surfaces. In other words, the first attachment surface 62a, the second attachment surface 62b, and the third attachment surface 62c may be provided to be continuous along the bottom surface and the vertical surfaces of the groove portion 60.

The attachment surface 62 is provided to be bilaterally symmetric about the center portion of the groove portion 60 in the longitudinal direction.

In such a manner, since a plurality of the attachment surfaces 62 having different inclination directions and the non-inclined surface are formed in the groove portion 60, the engagement force can be even more improved.

As shown in FIG. 8C, a plurality of attachment portions 71 for attaching the engaged portion 12 are formed in a groove portion 70 of the vehicle seat S1 of modification Example 3. The attachment portion 71 includes a first attachment portion 71a provided on one side in the longitudinal direction (the right side in the seat width direction) of the groove portion 70, and a second attachment portion 71b provided on the other side in the longitudinal direction (the right side in the seat width direction) of the groove portion 70.

An attachment surface 72 for attaching the engaged portion 12 is formed in each of the attachment portions 71. In addition, a non-attachment surface 73 on which the attachment portion 71 is not formed is provided in the groove portion 70. In other words, a bottom surface of the groove portion 70 is composed of the attachment surface 72 and the non-attachment surface 73.

As shown in FIG. 8C, the attachment surface 72 is inclined with respect to a perpendicular plane perpendicular to a depth direction of the groove portion 70.

In detail, the attachment surface 72 includes a first attachment surface 72a provided on the first attachment portion 71a, and a second attachment surface 72b provided on the second attachment portion 71b. Each of the first attachment surface 72a and the second attachment surface 72b is inclined with respect to the perpendicular plane. Specifically, the first attachment surface 72a is inclined upward from the right side to the left side in the longitudinal direction of the groove portion 70. The second attachment surface 72b is inclined downward from the right side to the left side in the longitudinal direction of the groove portion 70.

In such a manner, since a plurality of the attachment surfaces 72 having different inclination directions are formed in the groove portion 70, the engagement force can be even more improved. In addition, since the non-attachment surface 73 on which the attachment portion 71 (attachment surface 72) is not formed is formed in the groove portion 70, the length of the engaged portion 12 can be shortened. Therefore, the manufacturing cost of the vehicle seat S1 can be reduced.

As shown in FIG. 8D, a plurality of attachment portions 81 for attaching the engaged portion 12 are formed in a groove portion 80 of the vehicle seat S1 of Modification Example 4. The attachment portion 81 includes a first attachment portion 81a provided on one side in the longitudinal direction (the right side in the seat width direction) of the groove portion 80, and a second attachment portion 81b provided on the other side in the longitudinal direction (the right side in the seat width direction) of the groove portion 80.

An attachment surface 82 for attaching the engaged portion 12 is formed in each of the attachment portions 81. In addition, a plurality of non-attachment surfaces 83 on which the attachment portion 81 is not formed are provided in the groove portion 80. In other words, a bottom surface of the groove portion 80 is composed of the attachment surface 82 and the non-attachment surfaces 83.

As shown in FIG. 8D, the attachment surface 82 is inclined with respect to a perpendicular plane perpendicular to a depth direction of the groove portion 80.

In detail, the attachment surface 82 includes a first attachment surface 82a provided on the first attachment portion 81a, and a second attachment surface 82b provided on the second attachment portion 81b. Each Of the first attachment surface 82a and the second attachment surface 82b is inclined with respect to the perpendicular plane. Specifically, the first attachment surface 82a is inclined downward from the right side to the left side in the longitudinal direction of the groove portion 80. The second attachment surface 82b is inclined upward from the right side to the left side in the longitudinal direction of the groove portion 80.

In such a manner, since a plurality of the attachment surfaces 82 having different inclination directions are formed in the groove portion 80, the engagement force can be even more improved. In addition, since the plurality of non-attachment surfaces 83 on which the attachment portion 81 (attachment surface 82) is not formed are formed in the groove portion 80, the length of the engaged portion 12 can be even more shortened.

Therefore, the manufacturing cost of the vehicle seat S1 can be reduced.

### Second Embodiment

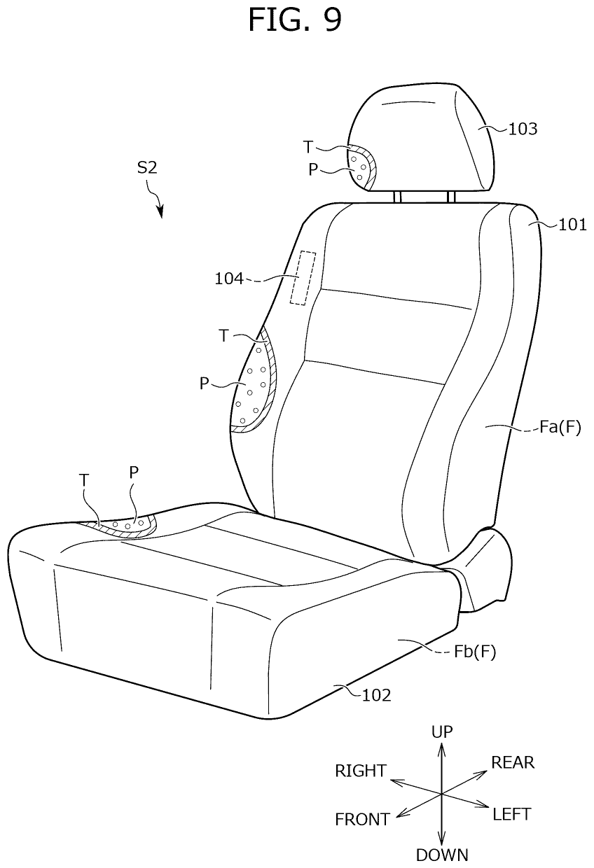

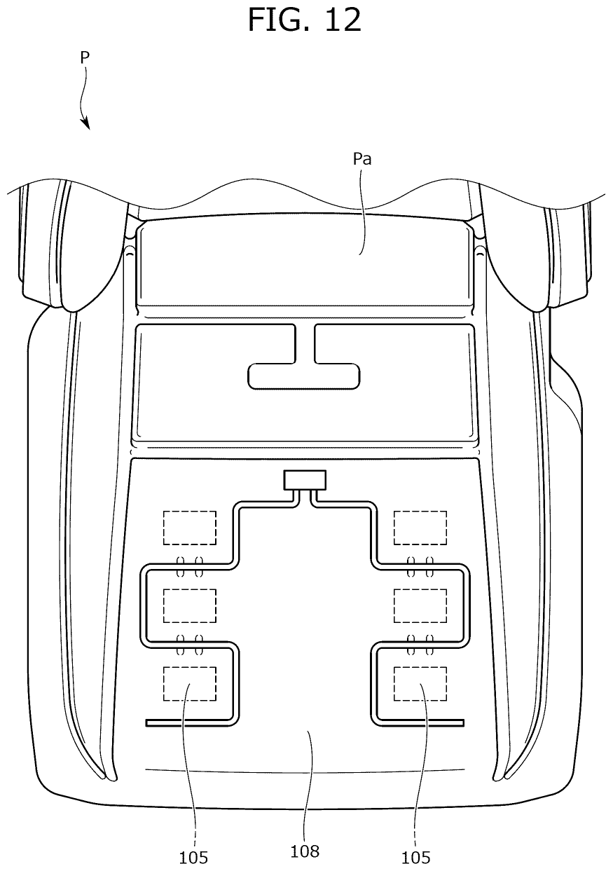

Hereinafter, an embodiment according to the present invention will be described with reference to FIGS. 9 to 16. A vehicle interior skin and a vehicle seat S2 of a second embodiment are configured to improve cushioning and recyclability while suppressing the occurrence of wrinkles.

### Overall Configuration of Seat

As shown in FIG. 9, the vehicle seat $2 of the present embodiment is a seat which is placed on a vehicle body floor and in which an occupant of a vehicle is seated. In the present embodiment, the vehicle seat S2 is used as a front seat corresponding to a front seat of the vehicle. However, the present invention is not limited to a front seat, and the vehicle seat S2 may be a rear seat of the vehicle, and can also be used as a middle seat in a second row or a rear seat in a third row of a vehicle including three rows of seats in the front to rear direction.

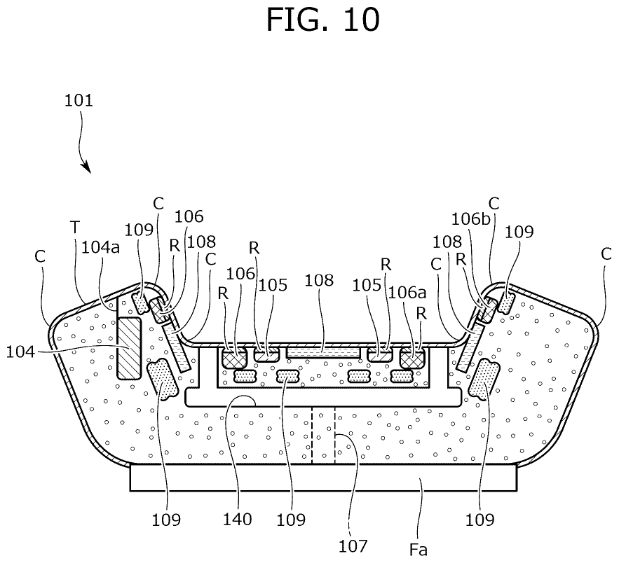

As shown in FIGS. 9 and 10, the vehicle seat S2 is mainly composed of a seat main body including a seat back 101, a seat cushion 102, and a headrest 103. In addition, the vehicle seat S2 includes an airbag device 104 provided a seat frame F; a detection unit 105 that is attached inside the seat main body and that detects the biological signals of a seated occupant seated in the seat main body; a notification unit 106 that applies vibration to the seated occupant; a blower device 107 that blows out air toward the seated occupant; a temperature adjustment unit 108 that adjusts the temperature of a seating surface; and a seat movement unit 109 that operates to cause a part of the seat main body to protrude toward the seated occupant side from a normal position.

The seat frame F is provided inside the vehicle seat S2. Each of the seat back 101 and the seat cushion 102 includes a pad material P disposed on the seat frame F, and a skin T that covers the pad material P.

As shown in FIGS. 9 and 10, the seat back 101 is a backrest portion that supports the back of the occupant from behind, and is configured by placing the pad material P on a back frame Fa serving as the skeleton of the seat back 101, and covering the back frame Fa and the pad material P with the skin T.

The seat cushion 102 is a seating portion that supports the occupant from below, and is configured by placing the pad material P on a cushion frame Fb serving as the skeleton of the seat cushion 102, and covering the cushion frame Fb and the pad material P with the skin T.

The headrest 103 is a head portion that supports the head of the occupant from behind, and is configured by placing the pad material P on a pillar (not shown) serving as a core material, and covering the pillar and the pad material P with the skin T.

As shown in FIG. 10, the airbag device 104 has a known configuration, is attached to the seat frame F, and includes an airbag and an inflator.

The airbag device 104 is disposed inside the seat back 101 and inside the skin T. When gas is ejected by the inflator and the airbag inflates out of a casing, the pad material P breaks along a tear line 104a, the skin T is cut open, and the airbag is deployed outward. Incidentally, the airbag device 104 may be provided in the seat cushion 102.

As shown in FIGS. 10 to 12, the detection unit 105 is a sheet-shaped pressure sensor that detects the seating pressure applied to the seating surfaces of the seat back 101 and the seat cushion 102 when the seated occupant is seated in the seat.

Here, the “seating pressure” is a value that changes periodically in response to the physiological activity of the seated occupant, specifically, breathing in a state where the seated occupant is seated on the seat back 101 and the seat cushion 102, and is a target value that is detected by the pressure sensor. That is, the “seating pressure” corresponds to the “biological signals (biological information) of the seated occupant”.

Incidentally, the detection unit 105 is a push switch type seating sensor that turns on and off depending on the seating pressure of the seated occupant, but is not limited thereto, and for example, the detection unit 105 may be a pulse wave sensor or a blood pressure sensor.

As shown in FIG. 10, the notification unit 106 is provided on the pad material P, and notifies the seated occupant of information. Specifically, the notification unit 106 is a vibration device including a vibration motor that applies a physical force to the seated occupant, and the notification unit 106 notifies the seated occupant of information by applying vibration to the seated occupant.

Incidentally, the notification unit 106 may be a light generation device such as lighting that provides a notification of information through light, or may be a sound generation device that provides 3 notification of information through sound.

The notification unit 106 is provided on the pad material P, and includes vibration units 106a provided in a center portion of the seat back 101, and side vibration units 106b provided in side portions of the seat back 101. The vibration units 106a and the side vibration units 106b can apply stimulation to the back of the seated occupant. Incidentally, the notification unit 106 may be provided in the seat cushion 102. In this case, the notification unit 106 can apply stimulation to the buttocks of the seated occupant.

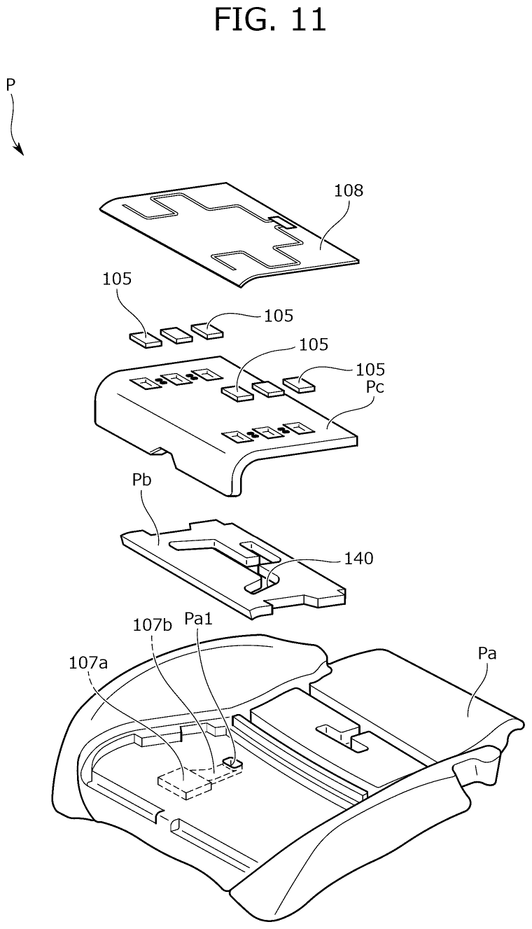

As shown in FIGS. 10 and 11, the blower device 107 is provided on each of the seat frames F of the seat back 101 and the seat cushion 102. The blower device 107 includes a blower main body 107a that blows out air, and a duct 107b through which the air passes.

The blower main body 107a is attached to the cushion frame Fb of the seat cushion 102. The duct 107b is attached to each of the seat frames F of the seat back 101 and the seat cushion 102. The air blown out from the blower main body 107a passes through the duct 107b, and is sent to each of the seat back 101 and the seat cushion 102. Incidentally, the blower main body 107a may be provided on each of the seat frames F of the seat back 101 and the seat cushion 102.

As shown in FIGS. 10 to 12, the temperature adjustment unit 108 is a device that is provided between the skin I and the pad material P of each of the seat back 101 and the seat cushion 102, and that adjusts the temperature of the seating surface portion of each of the seat back 101 and the seat cushion 102. For example, the temperature adjustment unit 108 includes a temperature sensor (for example, a thermistor); a heating element (for example, a heater) for heating the seating surface; and a cooling element (for example, a Peltier element) for cooling the seating surface. Then, the temperature adjustment unit 108 operates such that the temperature of the seating surface of the seat back 101 is brought closer to a target value set in advance by switching the heating element and the cooling element between ON and OFF in accordance with the temperature detected by the temperature sensor and the target temperature set in advance.

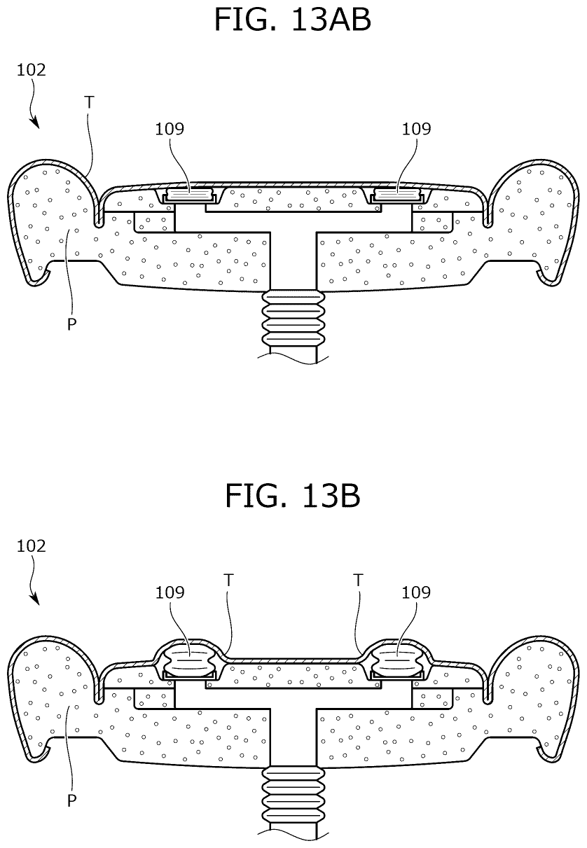

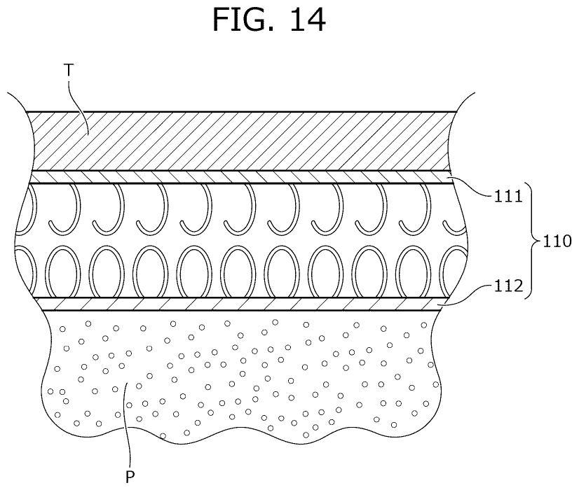

As shown in FIGS. 13A and 13B, the seat movement unit 109 is an electric device that operates to cause the seat back 101 and the seat cushion 102 to protrude. The seat movement unit 109 is, for example, a movable body including an air cell, and is provided on the pad material P.

As the air cell of the seat movement unit 109 is filled with compressed air, the air cell inflates toward the occupant (seated occupant) side to protrude from the normal position (FIG. 13A) to a protruding position (FIG. 13B). Then, as the filled compressed air is discharged, the air cell of the seat movement unit 109 deflates and returns to the normal position.

In addition, as shown in FIG. 14, the vehicle seat S2 includes an engaging member 110 for pulling the skin T into the pad material P.

The engaging member 110 is a hook-and-loop fastener having a strip shape, and includes an engaging portion 111 provided on the skin T, and an engaged portion 112 provided on the pad material P and engaged with the engaging portion 111. The skin T is fixed to the pad material P by the engaging portion 111 being engaged with the engaged portion 112 and being pulled in.

Incidentally, a clip member having a lower engagement force than a hook-and-loop fastener is provided in a groove portion Pd of the pad material P (to be described later) which is provided at a position corresponding to the airbag device 104.

As shown in FIG. 14, the engaging portion 111 is a hook portion of a hook-and-loop fastener for pulling in the skin T (specifically, a skin material 120 to be described later). The engaging portion 111 engages with the engaged portion 112 provided on the pad material P. Incidentally, the engaging portion 111 may be a loop portion of a hook-and-loop fastener.

The engaging portion 111 is made of resin, and is formed from, for example, a polyester resin such as polyethylene terephthalate (PET). Incidentally, the engaging portion 111 may be formed from polypropylene resin, polyethylene resin, or the like.

The engaging portion 111 extends longitudinally along a pull-in end portion of the skin T, and is sewn together with the skin T using a sewing thread ST made of polyester fibers.

As shown in FIG. 14, the engaged portion 112 is a loop portion for hooking the engaging portion 111. The engaged portion 112 is provided inside the groove portion Pd of the pad material P. Incidentally, the engaged portion 112 may be a hook portion of a hook-and-loop fastener.

The engaged portion 112 is made of resin, and is formed from, for example, polyurethane (PU) resin. Incidentally, the engaged portion 112 may be formed from polypropylene (PP) resin, polyacetal (POM) resin, polyamide (PA) resin, polycarbonate (PC) resin, or the like.

The engaged portion 112 is integrally formed, for example, during foam molding of the pad material P made of polyurethane, and is attached to the pad material P in a state where a part of the engaged portion 112 is embedded in the pad material P.

### Skin

As shown in FIGS. 9 and 10, the skin T (vehicle interior skin) is attached to cover the pad material P, which is provided in the vehicle seat S2, in a state where the skin T is stretched with a predetermined tension. The skin T is fixed to the pad material P by the engaging portion 111 being engaged with the engaged portion 112 and being pulled in.

In the present embodiment, an example in which the vehicle interior skin is the skin T that covers the pad material P of the vehicle seat S2 will be described. However, the present invention is not limited thereto, and the vehicle interior skin may be a skin that covers a pad material provided in a vehicle door.

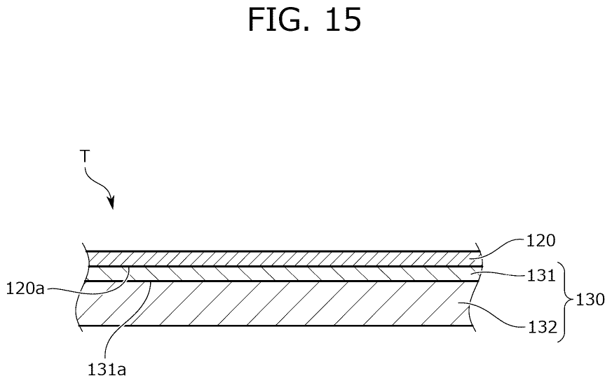

As shown in FIG. 15, the skin T has a laminated structure, and includes the skin material 120 serving as the front surface of the vehicle seat S2, and a cushion layer 130 provided on a skin material back surface 120a on the pad material P side of the skin material 120.

The cushion layer 130 is provided over the entire skin material back surface 120a of the skin material 120. Incidentally, the cushion layer 130 may be provided on a part of the skin material back surface 120a of the skin material 120.

The skin material 120 is provided to be located on a front side (an exposed side facing the seated occupant) in a thickness direction of the skin T, and is a covering material forming the appearance of the vehicle seat S2.

The skin material 120 is formed using threads made of polyester fibers. Examples of polyester fibers include polyethylene terephthalate (PET) , polytrimethylene terephthalate (PTT), polybutylene terephthalate (PBT) , polybutylene naphthalate (PEN), polybutylene naphthalate (PBN), polypropylene (PP), polylactic acid (PLA), and the like. The abrasion resistance can be enhanced by adopting threads made of polyester fibers.

The cushion layer 130 is provided to be located on a back side (a side facing the pad material P) in the thickness direction of the skin T.

The cushion layer 130 includes a stretch layer 131 provided on the skin material back surface 120a on the pad material P side of the skin material 120 and having stretchability, and a nonwoven fabric 132 provided on a stretch layer back surface 131a on the pad material P side of the stretch layer 131 and disposed to face the pad material P.

The stretch layer 131 is a base fabric having stretchability, and is formed using threads made of polyester fibers. Examples of polyester fibers include polyethylene terephthalate (PET), polytrimethylene terephthalate (PTT), polybutylene terephthalate (PBT), polybutylene naphthalate (PEN), polybutylene naphthalate (PBN), polypropylene (PP), polylactic acid (PLA), and the like. The abrasion resistance can be enhanced by adopting threads made of polyester fibers.

The stretch layer 131 is disposed at positions corresponding to the corners of the pad material P. Specifically, as shown in FIG. 10, the stretch layer 131 is disposed at corner portions C in the side portions of the seat back 101 and at the corner portions C between the center portion and the side portions of the seat back 101.

In such a manner, since the stretch layer 131 having stretchability is provided at least at the corners of the pad material P, the occurrence of wrinkles on the skin T can be suppressed when the skin T is pulled into the pad material P. Incidentally, the stretch layer 131 is disposed only at the positions corresponding to the corners of the pad material P.

The nonwoven fabric 132 is, for example, a needle-punched nonwoven fabric having cushioning, and is made of polyester fibers. Examples of polyester fibers include polyethylene terephthalate (PET) , polytrimethylene terephthalate (PTT) , polybutylene terephthalate (PBT) , polybutylene naphthalate (PEN), polybutylene naphthalate (PBN), polypropylene (PP), polylactic acid (PLA), and the like. The abrasion resistance can be enhanced by adopting threads made of polyester fibers.

The nonwoven fabric 132 is disposed at a position corresponding to the seating surface of the pad material P. In such a manner, since the nonwoven fabric 132 having cushioning is provided at least on the seating surface of the pad material P, the seating comfort can be improved. Incidentally, the nonwoven fabric 132 may be disposed only at the position corresponding to the seating surface of the pad material P.

The skin material 120, the stretch layer 131, and the nonwoven fabric 132 are sewn together using the sewing thread ST to form the skin T.

The sewing thread ST is formed from polyester fibers. Examples of polyester fibers include polyethylene terephthalate (PET), polytrimethylene terephthalate (PTT), polybutylene terephthalate (PBT), polybutylene naphthalate (PEN), polybutylene naphthalate (PBN), polypropylene (PP), polylactic acid (PLA), and the like.

In such a manner, since the skin T has a three-layer structure made up of the skin material 120, the stretch layer 131 having stretchability, and the nonwoven fabric 132 having cushioning, it is possible to enhance cushioning while suppressing the occurrence of wrinkles.

In addition, the abrasion resistance and quick-drying properties of the skin can be improved by using polyester fibers.

### Pad

In the pad material P, a cushion portion is formed from a foam, and the cushion portion is covered with the skin T. As the foam, polypropylene bead foam, polyethylene bead foam, polypropylene foam, polyethylene foam, acrylonitrile-styrene foam, ethylene vinyl acetate copolymer resin, urethane foam material, or the like, or a combination thereof is used. In the present embodiment, the pad material P is a polyurethane pad molded by foam molding using a urethane foaming agent.

As shown in FIG. 10, each seat component (the airbag device 104, the detection unit 105, the notification unit 106, the blower device 107, the temperature adjustment unit 108, and the seat movement unit 109) is provided on the pad material P.

In addition, a rubber member R for improving seating comfort is provided on the seating surface side of the detection unit 105 and the notification unit 106.

As shown in FIG. 11, the pad material P includes a pad main body Pa; a passage forming portion Pb in which an air passage portion 140 through which the air sent from the blower device 107 passes is formed; and a sensor attachment portion Pc to which the detection unit 105 is attached.

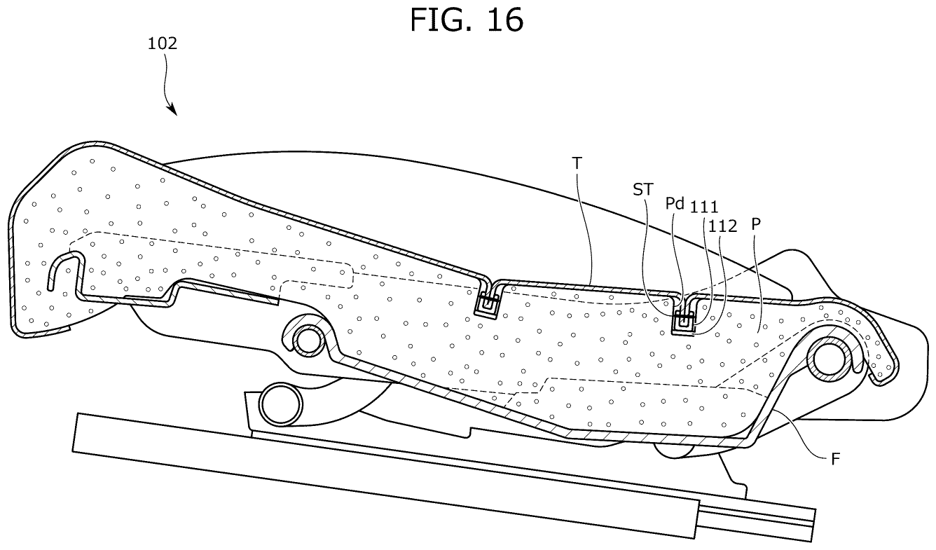

In addition, as shown in FIG. 16, the long groove portion Pd for pulling in the skin T is formed in the pad material P. A plurality of groove portions Pd are formed in each of the pad materials P of the seat back 101 and the seat cushion 102. Incidentally, the number or disposition of the groove portions Pd is one example, and is not limited thereto.

A blowing port Pa1 for blowing out the air sent from the duct 107b of the blower device 107 is formed in the pad main body Pa.

The air passage portion 140 through which the air sent from the blowing port Pa1 passes toward the skin T side is formed in the passage forming portion Pb. The air passage portion 140 is formed in a predetermined arrangement pattern, and a plurality of the air passage portions 140 are formed over the entire seating surface. Incidentally, the pad material P is formed from polyurethane, and the pad material P has breathability throughout, and therefore, the air can pass through the entire pad material P except for the air passage portion 140.

A plurality of the detection units 105 are attached to the sensor attachment portion Pc. In addition, the temperature adjustment unit 108 is disposed above the sensor attachment portion Pc.

### Materials for Components of Vehicle Seat

Here, materials for the components of the vehicle seat S2 will be described with reference to FIG. 16.

The seat frame F on which the pad material P is disposed is formed from a metal having rigidity such as steel, aluminum alloy, or magnesium alloy.

The pad material P is formed from a material different from those of the seat frame F and the skin T. Specifically, the pad material P is formed from polyurethane. In addition, the engaged portion 112 provided on the pad material P is formed from the same material as the pad material P. Specifically, the engaged portion 112 is formed from polyurethane.

The skin T is formed from a material different from those of the seat frame F and the pad material P. Specifically, the skin T is formed from polyester. In addition, the engaging portion 111 provided on the skin T is formed from the same material as the skin T. Specifically, the engaging portion 111 is formed from polyester.

When the vehicle seat S2 is disposed of, there is need to separate the seat frame F, the pad material P, and the skin T since the seat frame F, the pad material P, and the skin T are formed from different materials. In this case, since the engaging portion 111 is formed from the same material as the skin T, there is no need to separate the engaging portion 111 from the skin T. In addition, since the engaged portion 112 is formed from the same material as the pad material P, there is no need to separate the engaged portion 112 from the pad material P.

Therefore, the ease of disassembly of the vehicle seat $2 can be enhanced. In addition, the recyclability of the vehicle seat S2 can be improved.

In addition, in the skin T, the engaging portion 111, the skin material 120, the stretch layer 131, the nonwoven fabric 132, and the sewing thread ST are formed from polyester fibers.

In such a manner, since the engaging portion 111, the skin material 120, the stretch layer 131, the nonwoven fabric 132, and the sewing thread ST are formed from the same material (polyester), there is no need to separate the engaging portion 111, the skin material 120, the stretch layer 131, the nonwoven fabric 132, and the sewing thread ST during disposal of the skin T. Therefore, the recyclability can be improved.

### Disposition of Skin, Pad Material, and Seat Components

Next, the disposition of the skin T, the pad material P, and the seat components will be described with reference to FIGS. 10, 13A, and 13B.

The skin T is disposed at the position where the skin I overlaps each seat component (the airbag device 104, the detection unit 105, the notification unit 106, the blower device 107, the temperature adjustment unit 108, and the seat movement unit 109), which is provided on the pad material P or the seat frame F, in the thickness direction of the pad material P.

In detail, as shown in FIG. 10, the skin T is disposed at the position where the skin T overlaps the air passage portion 140 in the thickness direction of the pad material P.

The nonwoven fabric 132 having high breathability is provided on the skin T. Therefore, since the breathability of a portion of the skin T, which overlaps the air passage portion 140, is improved, the air passing through the air passage portion 140 is easily sent to the seated occupant.

In addition, as shown in FIG. 10, the skin T is disposed at the position where the skin T overlaps the detection unit 105 in the thickness direction of the pad material P.

The nonwoven fabric 132 that is thinner than the base material such as a soft foam is provided on the skin T. Therefore, since the skin T is formed thin, for example, when a seating sensor is provided on the pad material P as the detection unit 105, the detection sensitivity of the sensor can be improved.

In addition, as shown in FIG. 10, the skin T is disposed at the position where the skin T overlaps the notification unit 106 in the thickness direction of the pad material P.

The nonwoven fabric 132 that is thinner than the base material such as a soft foam is provided on the skin T. Therefore, since the skin T is formed thin, for example, when a vibration device is provided on the pad material Pas the notification unit 106, the vibration of the vibration device can be appropriately transmitted to the seated occupant.

In addition, as shown in FIG. 10, the skin T is disposed at the position where the skin T overlaps the temperature adjustment unit 108 in the thickness direction of the pad material P.

The nonwoven fabric 132 that is thinner and has lower heat insulating properties than the base material such as a soft foam is provided on the skin T. Therefore, since the skin T is formed thin, for example, when a heater is provided on the pad material P as the temperature adjustment unit 108, the heat of the heater can be easily transferred to the seated occupant.

In addition, as shown in FIGS. 13A and 13B, the skin T is disposed at the position where the skin T overlaps the seat movement unit 109 in the thickness direction of the pad material P.

The skin T is provided with the stretch layer 131 having high stretchability. Therefore, since the skin T is easily stretched, for example, when an air cell serving as the seat movement unit 109 inflates, wrinkles are less likely to occur in the skin T.

### Supplementary Note

The above-described problem is solved by a vehicle interior skin of the present invention that covers a front surface of a pad material, the vehicle interior skin including: a skin material serving as the front surface; and a cushion layer provided on a surface on a pad material side of the skin material. The cushion layer includes a stretch layer provided on the surface on the pad material side of the skin material and having stretchability, and a nonwoven fabric provided on a surface on the pad material side of the stretch layer and disposed to face the pad material. The skin material, the stretch layer, and the nonwoven fabric are formed from the same material.

With the above-described configuration, since the skin material, the stretch layer, and the nonwoven fabric are formed from the same material, there is no need to separate the skin material, the stretch layer, and the nonwoven fabric during disposal of the skin T. In addition, the occurrence of wrinkles can be suppressed by providing the stretch layer. In addition, cushioning can be enhanced by providing the nonwoven fabric.

Therefore, it is possible to improve cushioning and recyclability while suppressing the occurrence of wrinkles.

In this case, it is preferable that the skin material, the stretch layer, and the nonwoven fabric are formed from polyester fibers.

With the above-described configuration, since polyester fibers are used as the material for the vehicle interior skin, the stretch of the fibers can be appropriately suppressed, and the occurrence of wrinkles can be further Suppressed.

In this case, it is preferable that the stretch layer is disposed at least at a position corresponding to a corner of the pad material.

With the above-described configuration, since the stretch layer having stretchability is provided at the corner of the pad material where wrinkles are likely to occur, the occurrence of wrinkles can be even more suppressed.

In this case, it is preferable that the nonwoven fabric is disposed at least at a position corresponding to a seating surface of the pad material.

With the above-described configuration, since the nonwoven fabric having cushioning is provided on the seating surface of the pad material, the seating comfort of a seated occupant can be improved.

In this case, it is preferable that the vehicle interior skin further includes an engaging portion that engages with an engaged portion provided on the pad material and that is used for pulling in the skin material. It is preferable that the engaging portion is formed from the same material as the material of the skin material, the stretch layer, and the nonwoven fabric.

With the above-described configuration, even when the engaging portion for pulling the skin material into the skin, there is no need to separate the skin material and the engaging portion during disposal of the skin, since the skin material and the engaging portion are formed from the same material.

In this case, it is preferable that the engaging portion is a hook portion or a loop portion of a hook-and-loop fastener.

With the above-described configuration, the engagement strength of the skin with respect to the pad material can be increased.

In this case, it is preferable that the skin material, the stretch layer, and the nonwoven fabric are sewn together using a sewing thread, and it is preferable that the sewing thread is formed from polyester fibers.

With the above-described configuration, since the skin material, the stretch layer, the nonwoven fabric, and the sewing thread are made of polyester fibers, there is no need to separate the skin material, the stretch layer, the nonwoven fabric, and the sewing thread during disposal of the skin.

In addition, the above-described problem is solved by a vehicle seat including a vehicle interior skin of the present invention, the vehicle seat including: a frame; a pad material disposed on the frame; the vehicle interior skin that covers a front surface of the pad material; and a blower device provided on the frame. An air passage portion through which air sent from the blower device passes is formed in the pad material. At least a part of the vehicle interior skin is disposed at a position where at least the part overlaps the air passage portion in a thickness direction of the pad material.

With the above-described configuration, since a nonwoven fabric having high breathability is provided, the breathability of a portion of the skin, which overlaps the air passage portion, is improved. Therefore, the air passing through the air passage portion can be easily sent to a seated occupant, and the air can be appropriately sent to the seated occupant.

In addition, the above-described problem is solved by a vehicle seat including a vehicle interior skin of the present invention, the vehicle seat including: a frame; a pad material disposed on the frame; and the vehicle interior skin that covers a front surface of the pad material. A temperature adjustment unit is provided on the pad material. At least a part of the vehicle interior skin is disposed at a position where at least the part overlaps the temperature adjustment unit in a thickness direction of the pad material.

With the above-described configuration, since a nonwoven fabric that is thinner than the base material such as a soft foam is provided, the skin is formed thin. Therefore, the heat of a heater or the like can be easily transferred to a seated occupant, and the seated occupant can be appropriately warmed.

In addition, the above-described problem is solved by a vehicle seat including a vehicle interior skin of the present invention, the vehicle seat including: a frame; a pad material disposed on the frame; and the vehicle interior skin that covers a front surface of the pad material. A notification unit is provided on the pad material. At least a part of the vehicle interior skin is disposed at a position where at least the part overlaps the notification unit in a thickness direction of the pad material.

With the above-described configuration, since a nonwoven fabric that is thinner than the base material such as a soft foam is provided, the skin is formed thin. Therefore, the vibration or the like of a vibration device can be easily transmitted to a seated occupant, and the seated occupant can be appropriately notified of information.

In addition, the above-described problem is solved by a vehicle seat including a vehicle interior skin of the present invention, the vehicle seat including: a frame; a pad material disposed on the frame; and the vehicle interior skin that covers a front surface of the pad material. A detection unit is provided on the pad material. At least a part of the vehicle interior skin is disposed at a position where at least the part overlaps the detection unit in a thickness direction of the pad material.

With the above-described configuration, since nonwoven fabric that is thinner than the base material such as a soft foam is provided, the skin is formed thin. Therefore, the detection sensitivity of a seating sensor or the like can be improved.

### Third Embodiment

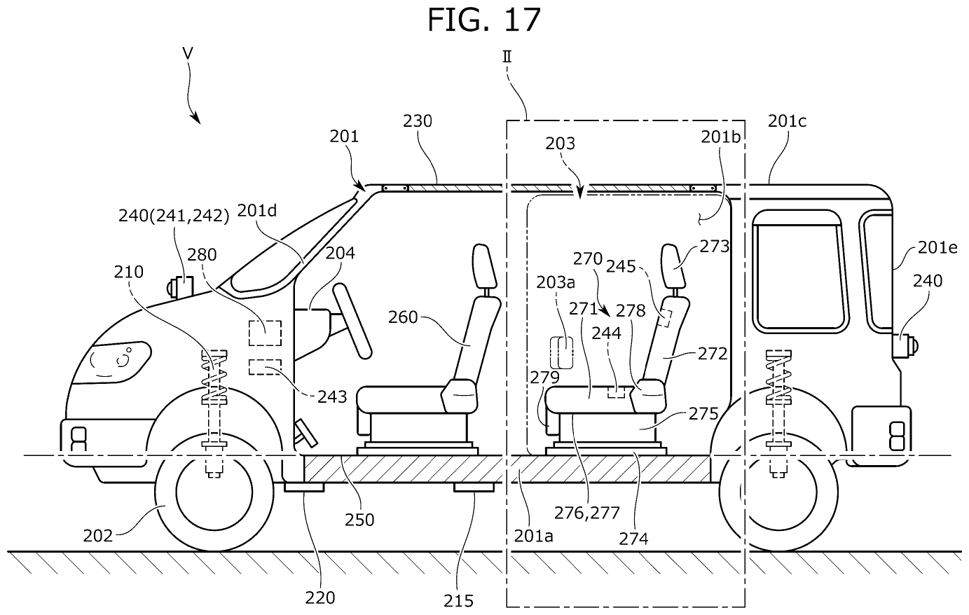

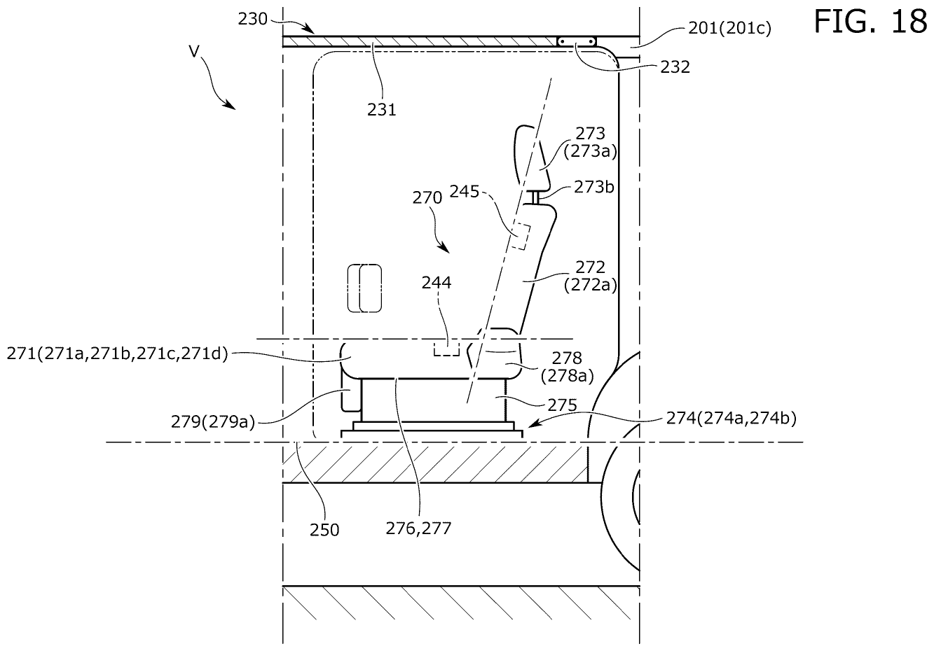

Hereinafter, an embodiment according to the present invention will be described with reference to FIGS. 17 to 24.

A vehicle V of a third embodiment relates to a “vehicle” that allows an occupant to get in and out appropriately and to drive the vehicle.

Incidentally, the “front to rear direction of the vehicle” refers to a front to rear direction of the vehicle during normal travel. The “inside in a width direction of the vehicle” refers to an interior side of the vehicle (vehicle interior side) with respect to a vehicle door, and the “outside in the width direction of the vehicle” refers to an exterior side of the vehicle (vehicle exterior side) with respect to the vehicle door.

### Hardware Configuration of Vehicle

The vehicle V is an automobile that realizes the ability for the occupant to ride comfortably during traveling of the vehicle V and to get in and out of the vehicle V conveniently. That is, the vehicle V is an automobile that realizes ensuring ride comfort during travel and ensuring the ease of getting in and out by the occupant.

For example, by lowering a vehicle floor as much as possible when the occupant gets in and out of the vehicle, it becomes easier for the occupant to get in and out. In addition, by setting the height of a vehicle seat (seat cushion) relatively high, it becomes easier for the occupant to be seated and stand up. In addition, by tilting the seat cushion slightly forward, it becomes easier for the occupant to be seated and stand up.

As shown in FIG. 17, the vehicle V is an automobile including two rows of vehicle seats 260 and 270 in the front to rear direction of the vehicle V. Incidentally, the vehicle V may be an automobile including one, three, or four or more rows of vehicle seats.

In the present embodiment, a configuration in which the vehicle seat 270 (rear seat) operates will be described; however, the vehicle seat 260 (front seat) also operates in the same manner, Incidentally, the configuration may be such that, of the vehicle seats 260 and 270, only the vehicle seat 270 is driven to operate, or the configuration may be such that only the vehicle seat 260 is driven to operate.

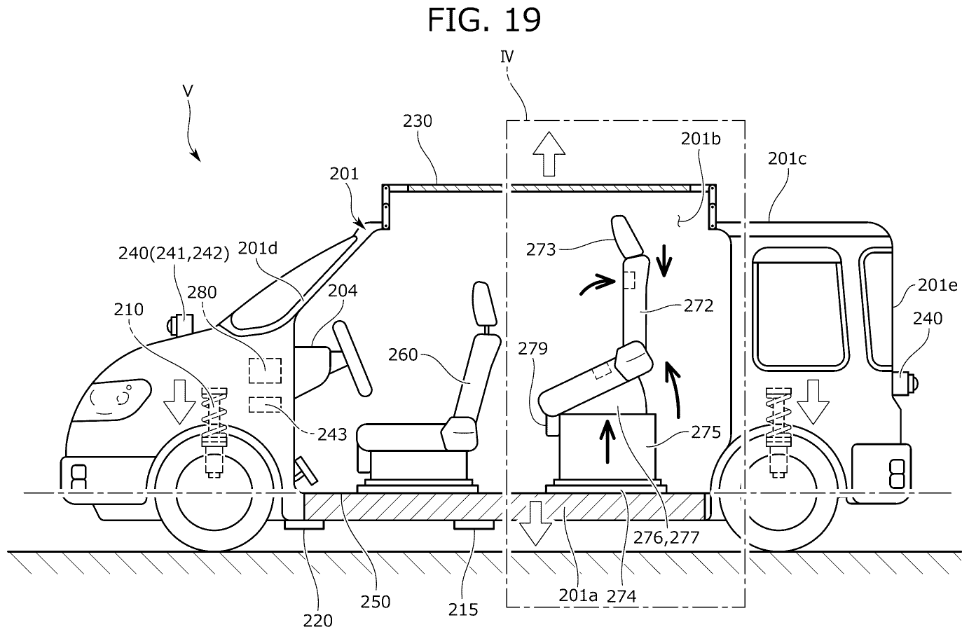

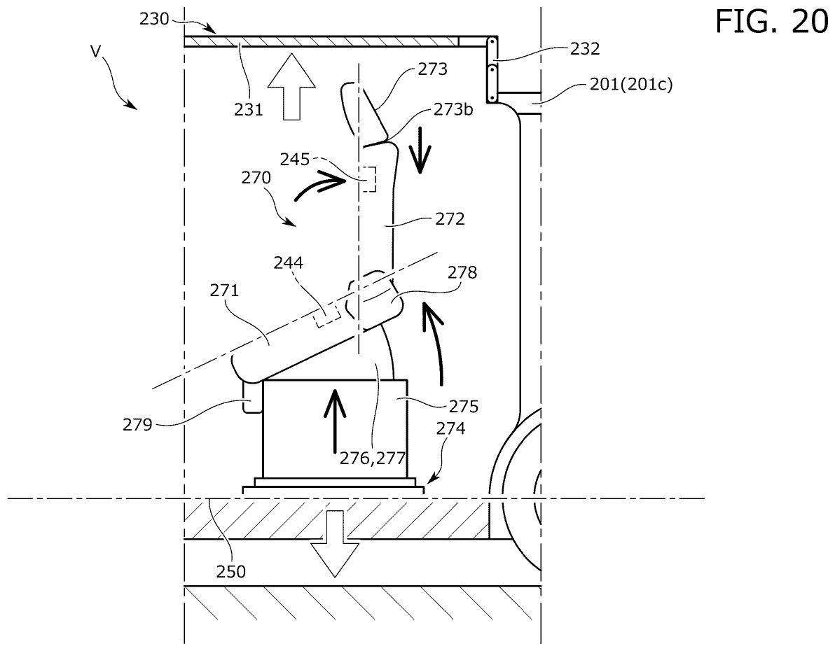

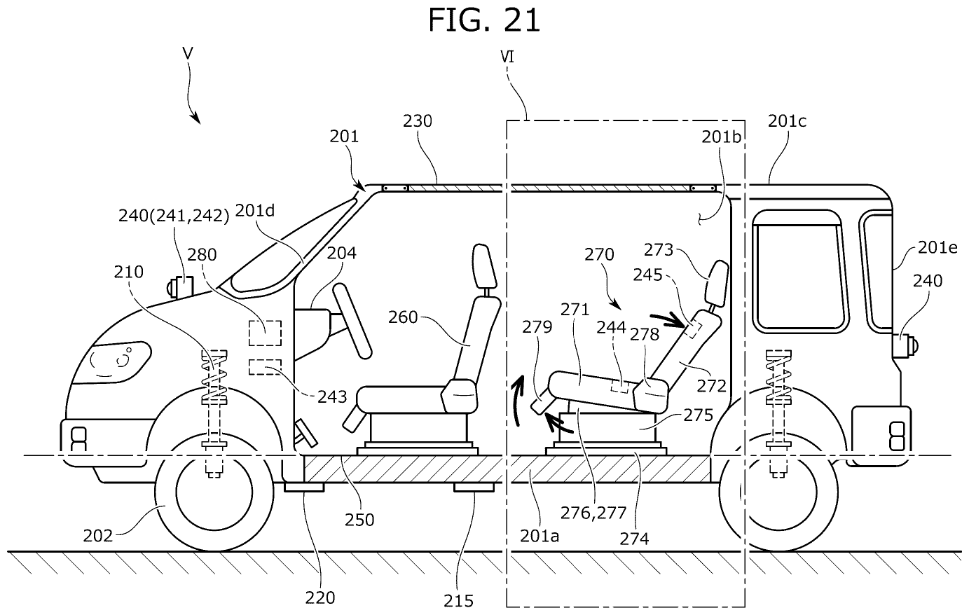

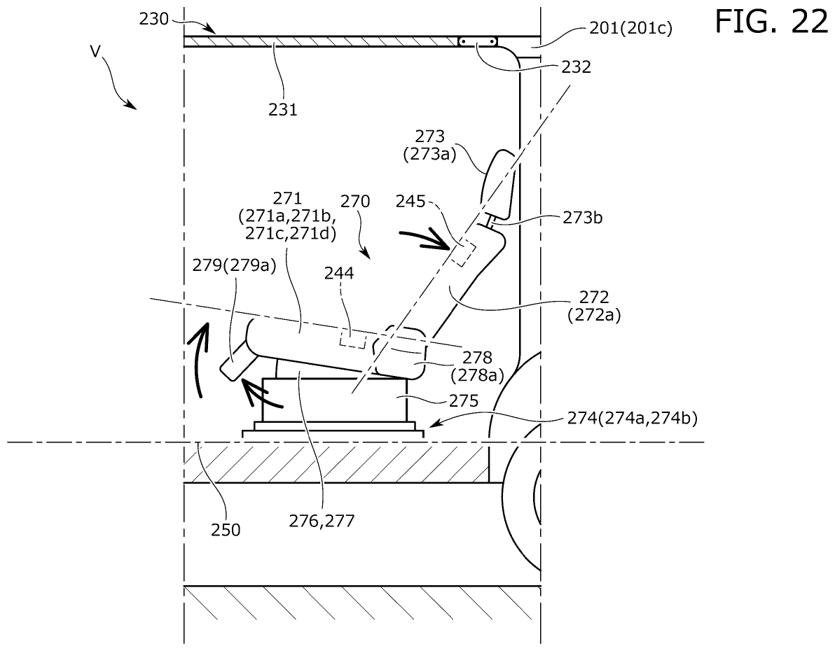

The vehicle V can switch the mode of the vehicle V between a “traveling mode (first mode)” shown in FIGS. 17 and 18, a “getting in/out mode (second mode)” shown in FIGS. 19 and 20, and a “rest mode (third mode) ” shown in FIGS. 21 and 22 by means of a vehicle control device 280.

The “traveling mode” is a mode for allowing the vehicle V to travel. The “getting in/out mode” is a mode for allowing the occupant to get in and out of the vehicle V. The “rest mode” is a mode for allowing the occupant to relax in a state where the occupant is seated in the vehicle seat 270.

The vehicle control device 280 can control the operation of vehicle devices (vehicle device group) installed in the vehicle V in accordance with each mode.

Incidentally, the vehicle V may be controlled by the vehicle control device 280 to be in a “stop mode (a reference mode and a fourth mode)” by default in which the vehicle V is stopped.

As shown in FIG. 17, the vehicle V includes a vehicle body 201; wheels 202 for traveling the vehicle body 201; a vehicle door 203; a vehicle height adjustment device 210 that connects the vehicle body 201 and the wheels 202 and that adjusts the height of the vehicle body 201 (vehicle height); a distance sensor 215; a vehicle inclination measurement device 220; a roof movement device 230; an onboard sensor 240; a vehicle floor 250; the vehicle seats 260 and 270 attached to the vehicle floor 250; and the vehicle control device 280 that controls a vehicle device group.

The vehicle body 201 corresponds to a vehicle main body, and includes a bottom wall portion 201a that forms a bottom wall of the vehicle V; a side wall portion 201b that forms side walls of the vehicle V; a top wall portion 201c that forms a ceiling (roof) of the vehicle V; a front wall portion 201d; and a rear wall portion 201e.

The wheels 202 are attached to the four corners of the vehicle body 201 (bottom wall portion 201a), and function as traveling wheels.

The vehicle door 203 is attached to the vehicle body 201 (side wall portion 201b) so as to be openable and closable. Incidentally, a door opening and closing sensor is attached inside a door handle 203a of the vehicle door 203. When the door opening and closing sensor detects that the vehicle door 203 is opened, the door opening and closing sensor outputs a detection signal toward the vehicle control device 280.

The vehicle height adjustment device 210 corresponds to a suspension device, includes a mechanism for supporting the wheels 202 and absorbing shocks, and allows the vehicle V to stably travel.

The vehicle height adjustment device 210 includes suspension arms that support the wheels 202, springs, and dampers (also referred to as shock absorbers).

The vehicle height adjustment device 210 is a vehicle height adjustment type suspension device, and can adjust the height of the vehicle V (vehicle height). In other words, the distance between the ground (traveling surface) and the bottom wall portion 201a (vehicle floor 250) in an up to down direction by adjusting the vehicle height. Namely, the vehicle height adjustment device 210 can change the height position of the vehicle floor 250.

The distance sensor 215 is a sensor that measures the distance between the ground and the vehicle body 201 (bottom wall portion 201a) in the up to down direction, and is attached to a bottom surface of the bottom wall portion 201a. The distance sensor 215 measures the distance between the ground and the vehicle body 201, and transmits distance information toward the vehicle control device. Since the distance sensor 215 is provided, the contact of the vehicle body 201 with the ground can be suppressed.

The vehicle inclination measurement device 220 is a device that measures the degree of inclination of the vehicle V with respect to the traveling surface on which the vehicle V travels, and is attached to the bottom wall portion 201a of the vehicle V.

The vehicle inclination measurement device 220 includes, for example, an inclination sensor, measures the degree of inclination of the vehicle V using the inclination sensor, and transmits information on the degree of inclination of the vehicle V toward the vehicle control device 280.

Incidentally, the vehicle inclination measurement device 220 is attached to a center portion of the bottom wall portion 201a of the vehicle V, but may be attached to each of a front portion and a rear portion of the vehicle V, or the vehicle inclination measurement devices 220 may be attached to the four corners of the vehicle V. Alternatively, the vehicle inclination measurement device 220 may be a vehicle slope meter, and may be installed inside the vehicle V.

The roof movement device 230 is a device capable of moving a roof portion 231 in the up to down direction with respect to the top wall portion 201c, and is disposed at a position (a position directly above) corresponding to the vehicle seats 260 and 270.

The roof movement device 230 includes the roof portion 231 having a rectangular plate shape; a connecting link 232 (connecting member) that connects the roof portion 231 and the top wall portion 201c; and a drive motor (not shown).

The roof portion 231 is movable (rotatable) in the up to down direction by operating the roof movement device 230. The height of the ceiling (roof) directly above the vehicle seats 260 and 270 can be increased by moving the roof portion 231 upward.

Incidentally, the roof movement device 230 may change the height of the ceiling by sliding the roof portion 231 in the up to down direction. Alternatively, the roof movement device 230 may partially open the ceiling of the vehicle V by sliding the roof portion 231 forward and rearward or rightward and leftward. Alternatively, the ceiling may be partially opened by rotating the roof portion 231 forward and rearward or rightward and leftward.

The onboard sensor 240 includes a plurality of imaging devices 241 and LiDARs 242 that detect an external environment (moving objects, structures, and the like) around the vehicle V, and a gyro sensor 243 (acceleration sensor) that measures the angular velocity and acceleration of the vehicle V.

In addition, the onboard sensor 240 includes seating sensors 244 and 245 that are attached inside each of the vehicle Seats 260 and 270 and that detect the seating pressure of the occupant.

The imaging device 241 is a small camera that captures external images around the vehicle V, creates external image data to execute the “sensing function” and the “monitoring function” of the vehicle V, and transmits the external image data toward the vehicle control device 280.

The plurality of imaging devices 241 are installed in the vehicle V, and are attached to, for example, side portions of the vehicle V at a front position and side portions at a rear position.

The LIDAR 242 is a remote sensor that measures the distance to a target object by irradiating the target object with laser light and receiving reflected light from the target object, and that performs three-dimensional spatial imaging.

The LiDAR 242 acquires distance measurement data obtained by measuring the distance to the target object, and transmits the distance measurement data toward the vehicle control device 280.

The plurality of LiDARs 242 are installed in the vehicle V, and are attached to, for example, side portions of the vehicle V at a front position and side portions at a rear position.

The gyro sensor 243 measures the three-dimensional angular velocity and acceleration of the vehicle V, and transmits information on the acceleration and angular velocity of the vehicle V toward the vehicle control device 280.

Incidentally, the attachment positions of the imaging device 241, the LiDAR 242, and the gyro sensor 243 can be changed as appropriate.

The seating sensors 244 and 245 are pressure sensors that output detection signals toward the vehicle control device 280 when the seating sensors 244 and 245 detects that the occupant is seated.

The seating sensor 244 is attached to a front surface of a seat cushion 271. The seating sensor 45 is attached to front surface of a seat back 272.

The vehicle floor 250 is a floor for attaching the vehicle seats 260 and 270 or vehicle interior members, and is disposed slightly above the bottom wall portion 201a of the vehicle body 201.

A region surrounded by the vehicle floor 250, the side wall portion 201b, the top wall portion 201c, the front wall portion 201d, and the rear wall portion 201e inside the vehicle V forms the cabin (internal space) of the vehicle V. During traveling of the vehicle V or during rest, the occupant spends time inside the cabin.

As shown in FIGS. 17 and 18, the vehicle seat 260 is a front seat (a driver's seat or a passenger seat) disposed at the front of the vehicle V. The vehicle seat 270 is a rear seat disposed at the rear of the vehicle V.

Since the vehicle seats 260 and 270 have the same configuration, the vehicle seat 270 will be described in detail.

As shown in FIGS. 17 and 18, the vehicle seat 270 includes the seat cushion 271; the seat back 272; a headrest 273; a rail device 274; a height device 275; a tilt device 276; a seat inclination measurement device 277; and a reclining device 278.

The seat cushion 271, the seat back 272, and the headrest 273 correspond to a “seat main body”. In addition, the rail device 274, the height device 275, the tilt device 276, the seat inclination measurement device 277, and the reclining device 278 correspond to “seat movement devices (vehicle devices)”.

The seat cushion 271 is a seating portion that supports a seated occupant (occupant) from below, and includes a cushion frame 271a; a pad material; and a skin material that covers the cushion frame 271a and the pad material.

The cushion frame 271a is a frame-shaped frame, and includes right and left side frames 271b disposed on the lateral sides in the seat width direction; a pan frame 271c having a plate shape that connects front portions of the side frames 271b; and a rear connecting frame 271 d that connects rear portions of the side frames 271b.

The tilt device 276 and the seat inclination measurement device 277 are attached to the cushion frame 271a. In addition, the rail device 274 is attached to a lower portion of the cushion frame 271a via the height device 275. In addition, an ottoman device 279 is attached to a front portion of the cushion frame 271a.

The seat back 272 is a backrest portion that supports the seated occupant from behind, and includes a back frame 272a, a pad material, and a skin material.

The reclining device 278 is attached to a connecting portion between the cushion frame 271a and the back frame 272a.

The headrest 273 is a head portion that supports the head of the occupant from behind, and includes a head pillar 273a serving as a core material, a pad material, and a skin material.

A head drive device 273b is attached to a connecting portion between the back frame 272a and the head pillar 273a. The head drive device 273b is a drive motor type head height adjustment device, and is a device that connects the headrest 273 (head pillar 273a) to the back frame 272a so as to be movable up and down and that can fix the headrest 273.

The rail device 274 is attached between the vehicle floor 250 and the seat cushion 271 in the up to down direction. The rail device 274 includes right and left lower rails 274a fixed to the vehicle floor 250 and extending in the seat front to rear direction; right and left upper rails 274 b connected to be slidable along the lower rails 274a; a lock member that locks the upper rails 274b; and a drive motor.

The seat cushion 271 is attached to upper surfaces of the right and left upper rails 274b via the height device 275.

The height device 275 is attached between the rail device 274 and the seat cushion 271.

The height device 275 is, for example, a height link device, and includes right and left front links disposed at a seat front position; right and left rear links disposed at a seat rear position; a lock member that locks the seat cushion 271; and a drive motor.

The height device 275 can adjust the height of the seat cushion 271, for example, by using the rear links as drive links.

The tilt device 276 is attached to the cushion frame 271a.

The tilt device 276 includes a tilt rotation shaft supported on front portions of the right and left side frames 271b; a tilt bracket that connects the pan frame 271 c to the side frames 271b so as to be rotatable about the tilt rotation shaft; and a drive motor.

The tilt device 276 can tilt the seat cushion 271 forward or rearward by rotating the pan frame 271c upward with respect to the side frames 271b.

Incidentally, the tilt device 276 may tilt a part of the seat cushion 271 forward or rearward.

The seat inclination measurement device 277 is a device that measures the degree of inclination of the seat cushion 271 with respect to the vehicle floor 250, and is attached to the cushion frame 271a.

The seat inclination measurement device 277 includes, for example, an inclination sensor, measures the degree of inclination of the seat cushion 271 using the inclination sensor, and transmits information on the degree of inclination of the seat cushion 271 toward the vehicle control device 280.

The reclining device 278 is a device that rotatably connects the seat back 272 to the seat cushion 271 and that locks the seat back 272.

The reclining device 278 includes a reclining main body 278a that is driven when the seat back 272 is rotated; a back rotation shaft; a spiral spring that biases the seat back 272 so as to rotate forward about the back rotation shaft; and a drive motor.

The reclining main body 278a can switch the state of the seat back 272 between a “locked state” and an “unlocked state” where the seat back 272 is rotatable with respect to the seat cushion 271.

Incidentally, the back rotation shaft is supported on the seat cushion 271 side and the seat back 272 side in the seat width direction. One end portion of the spiral spring is locked to the seat cushion 271 side, and the other end portion of the spiral spring is locked to the seat back 272 side.

The ottoman device 279 is a device that rotatably connects a leg support member 279a to the seat cushion 271 and that locks the leg support member 279a.

The ottoman device 279 includes an ottoman rotation shaft supported by the cushion frame 271a; the leg support member 279a that rotates about the ottoman rotation shaft with respect to the cushion frame 271a; and a drive motor. The ottoman device 279 is a device capable of rotating the leg support member 279a between a “stowed position” and a “deployed position” where the leg support member 279a is rotated to the front side of the seat from the stowed position.

The vehicle control device 280 is a device that comprehensively performs electrical control of the vehicle V, and is, for example, an engine control unit (ECU). The vehicle control device 280 is installed, for example, inside a dashboard of the vehicle V.

The vehicle control device 280 is connected to the vehicle height adjustment device 210, the distance sensor 215, the vehicle inclination measurement device 220, the roof movement device 230, the onboard sensor 240, the head drive device 273b, the rail device 274, the height device 275, the tilt device 276, the seat inclination measurement device 277, the reclining device 278, and the ottoman device 279 through an onboard network.

Specifically, the vehicle control device 280 is a computer including a processor (CPU) serving as a data computation and control processing unit; a ROM and a RAM serving as storage devices; and a communication interface that transmits and receives information data through the onboard network.

A storage unit 281 of the vehicle control device 280 stores a vehicle program according to the present embodiment in addition to a main program that performs necessary functions for the computer. The functions of the vehicle V are realized by the execution of the program by the processor (CPU).

The vehicle control device 280 performs control to switch the mode of the vehicle V between the “traveling mode”, the “getting in/out mode”, and the “rest mode”.

### Functions of Vehicle

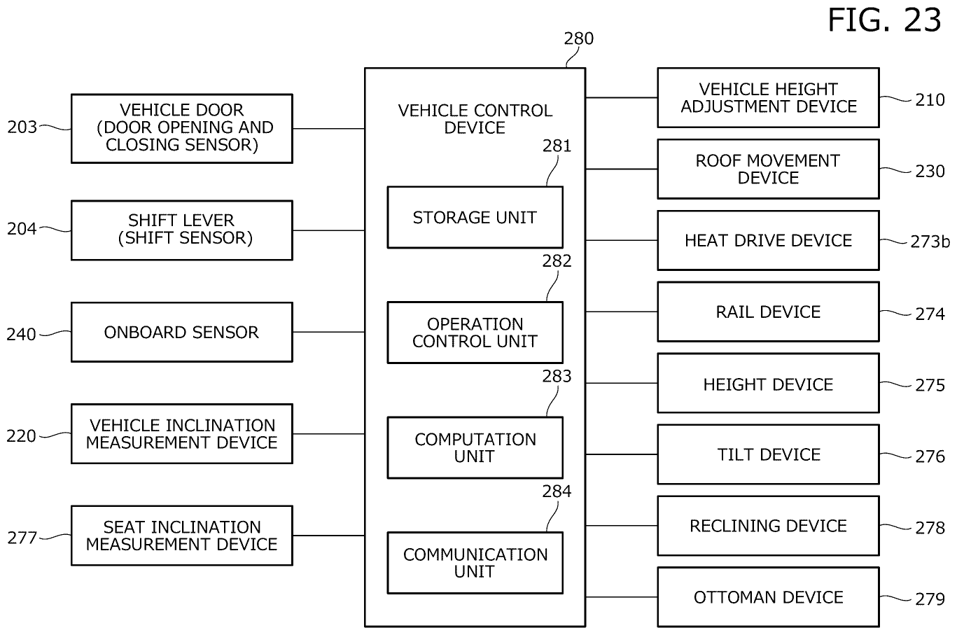

As shown in FIG. 23, from a functional standpoint, the vehicle control device 280 includes, main components, the storage unit 281 that stores various programs and various data; an operation control unit 282; a computation unit 283; and a communication unit 284.

These components are configured by a processor (CPU), a ROM, a RAM, an HDD, a communication interface, various programs, and the like.

The storage unit 281 stores “mode activation information (mode activation map)”.

The “mode activation information” includes information on a mode start condition and a mode switching condition for the traveling mode, the getting in/out mode, and the rest mode, and is managed and stored in the storage unit 281 in a centralized manner.

By referring to the “mode activation information”, the vehicle control device 280 can control the vehicle V to start in a predetermined mode or control the vehicle V to switch to the predetermined mode.

Hereinafter, the start condition (switching condition) for each mode will be described in detail.

### Start Condition (Switching Condition) for “Traveling Mode”

The condition for starting the “traveling mode” includes when it is detected that the occupant (driver) has operated a shift lever 204. Specifically, when it is detected that the shift lever 204 is set to drive, the operation control unit 282 performs control to set the mode of the vehicle V to the “traveling mode”.

In addition, when seat belts (belt buckles) provided on the vehicle seats 260 and 270 that are targets are locked, the operation control unit 282 performs control to switch the mode of the vehicle V to the “traveling mode”.

In addition, when the seating sensors 244 and 245 detect that the occupant is seated and the door opening and closing sensors detect that all the vehicle doors 203 are closed, the operation control unit 282 may switch the mode of the vehicle V to the “traveling mode”.

In addition, the operation control unit 282 may switch the mode of the vehicle V to the “traveling mode” simply when the occupant operates a mode switching operation switch.

### Start Condition (Switching Condition) for “Getting In/Out Mode”

The condition for starting the “getting in/out mode” includes when it is detected that the occupant has opened or closed the vehicle door 203 (door handle 203a). Specifically, when the door opening and closing sensor detects that the vehicle door 203 is opened, the operation control unit 282 performs control to set the mode of the vehicle V to the “getting in/out mode”.

In addition, when the occupant seated in the vehicle seat 260 or 270 places the hand on the vehicle door 203 (door handle 203a) and the seating sensor 244 detects a decrease in seating pressure, the operation control unit 282 may switch the mode of the vehicle V to the “getting in/out mode”. In addition, the operation control unit 282 may switch the mode of the vehicle V to the “traveling mode” simply when the occupant operates the mode switching operation switch. In addition, the operation control unit 282 may switch the mode of the vehicle V to the “traveling mode” when the occupant issues an instruction using a predetermined voice or issues an instruction using a predetermined gesture.

### Start Condition (Switching Condition) for “Rest Mode”

The condition for starting the “rest mode” includes when the seating sensors 244 and 245 of each of the vehicle seats 260 and 270 in which the occupants are seated detect a predetermined seating pressure (pressure) and when an increase or a decrease to the predetermined seating pressure is detected. For example, when the seating sensor 245 of the seat back 272 detects that the seating pressure has increased to the predetermined pressure within a predetermined time, and the seating sensor 244 of the seat cushion 271 detects that the seating pressure has decreased to the predetermined pressure within the predetermined time, the operation control unit 282 performs control to set the mode of the vehicle V to the “rest mode” In addition, it is detected that the occupant has operated the shift lever 204. For example, when it is detected that the shift lever 204 is set to parking, the operation control unit 282 performs control to set the mode of the vehicle V to the “rest mode”.

In addition, when the vehicle V travels autonomously, the operation control unit 282 may switch the mode of the vehicle V to the “rest mode.”

In addition, the operation control unit 282 may switch the mode of the vehicle V to the “rest mode” simply when the occupant operates the mode switching operation switch. In addition, the operation control unit 282 may switch the mode of the vehicle V to the “rest mode” when the occupant issues an instruction using a predetermined voice or issues an instruction using a predetermined gesture.

### Control of Traveling Mode

When the mode of the vehicle V is the “traveling mode, as shown in FIGS. 17 and 18, the operation control unit 282 controls the operation of the vehicle height adjustment device 210, the roof movement device 230, the head drive device 273b, the rail device 274, the height device 275, the tilt device 276, the reclining device 278, and the ottoman device 279.

Specifically, the operation control unit 282 controls the vehicle height adjustment device 210 to set the vehicle height to a “reference position (normal position)”, and controls the roof movement device 230 to set the height of the roof portion 231 to a “reference position”.

In addition, the operation control unit 282 controls the head drive device 273b to set the height of the headrest 273 to a “reference position (deployed position) ”, and controls the rail device 274 to set the front-to-rear position of the vehicle seat 270 to a “reference position”.

In addition, the operation control unit 282 controls the height device 275 to set the height of the seat cushion 271 to a “reference position (normal position) ”, and controls the tilt device 276 to set the tilt posture (tilt posture in the front to rear direction) of the seat cushion 271 to a “reference position (horizontal position)”. That is, the tilt device 276 is controlled to set the seating surface of the seat cushion 271 to be horizontal (substantially horizontal).

In addition, the operation control unit 282 controls the reclining device 278 to set the tilt posture of the seat back 272 to a “reference position (normal position)”, and controls the ottoman device 279 to set the leg support member 279a to a “reference position (stowed position)”. That is, the reclining device 278 is controlled to tilt the seating surface of the seat back 272 slightly rearward from the vertical.

As described above, the vehicle control device 280 controls the operation of each vehicle device, so that the occupant (driver) can drive the vehicle V more comfortably. Particularly, when the vehicle V is in the “traveling mode”, the vehicle height, the height of the seat cushion 271, and the tilt posture of the seat cushion 271 and the seat back 272 are controlled as described above, so that the occupant can drive the vehicle V comfortably.

### Control of Getting In/Out Mode

When the mode of the vehicle V is the “getting in/out mode, as shown in FIGS. 19 and 20, the operation control unit 282 controls the operation of the vehicle height adjustment device 210, the roof movement device 230, the head drive device 273b, the rail device 274, the height device 275, the tilt device 276, the reclining device 278, and the ottoman device 279.

Specifically, the operation control unit 282 controls the vehicle height adjustment device 210 to lower the vehicle height below the “reference position”, and controls the roof movement device 230 to raise the height of the roof portion 231 above “reference position”.

In addition, the operation control unit 282 controls the head drive device 273b to set the height of the headrest 273 to a “stowed position”, and controls the rail device 274 to set the front-to-rear position of the vehicle seat 270 to the “reference position”. Incidentally, the vehicle seat 270 may be moved to a position in front of or behind the “reference position” such that the occupant easily gets in and out.

In addition, the operation control unit 282 controls the height device 275 to raise the height of the seat cushion 271 above the “reference position”, and controls the tilt device 276 to tilt the tilt posture of the seat cushion 271 forward from the “reference position”. That is, the tilt device 276 is controlled to tilt the seating surface of the seat cushion 271 slightly forward from the horizontal.

In addition, the operation control unit 282 controls the reclining device 278 to tilt the tilt posture of the seat back 272 slightly rearward from the “reference position”, and controls the ottoman device 279 to set the leg support member 279a to the “reference position”. That is, as the seat cushion 271 is tilted forward by the tilt device 276, the reclining device 278 is controlled (correction control) to set the seating surface of the seat back 272 to be vertical or tilt the seating surface of the seat back 272 slightly rearward.

As described above, the vehicle control device 280 controls the operation of each vehicle device, so that it becomes easier for the occupant to get in and out. Particularly, when the vehicle V is in the “getting in/out mode”, the vehicle height, the height of the seat cushion 271, and the tilt posture of the seat cushion 271 and the seat back 272 are controlled as described above, so that it becomes easier for the occupants to be seated in the vehicle seats 260 and 270 and stand up.

As described above, when the vehicle V is in the “getting in/out mode”, the vehicle control device 280 controls the tilt device 276 to tilt the seating surface of the seat cushion 271 forward with respect to the floor surface of the vehicle floor 250. In addition, the vehicle control device 280 controls the tilt device 276 to tilt the seating surface of the seat cushion 271 forward with respect to the upper surfaces of the upper rails 274b.

Furthermore, the vehicle control device 280 acquires measurement information of the degree of inclination of the vehicle V from the vehicle inclination measurement device 220, and acquires measurement information of the degree of inclination of the seat cushion 271 from the seat inclination measurement device 277. Then, the tilt device 276 is controlled based on the acquired information to tilt the seating surface of the seat cushion 271 forward with respect to the ground (traveling surface).

Accordingly, the seating surface of the seat cushion 271 can be adjusted more appropriately, and the occupant can get in and out more appropriately (comfortably).

As described above, when the vehicle V is in the “getting in/out mode”, the vehicle control device 280 controls the reclining device 278 to set the seating surface of the seat back 272 to be perpendicular to the floor surface of the vehicle floor 250.

Furthermore, the vehicle control device 280 acquires measurement information of the degree of inclination of the vehicle V and measurement information of the degree of inclination of the seat cushion 271. Then, the reclining device 278 is controlled based on the acquired information to set the seating surface of the seat back 272 to be perpendicular to the ground.

Accordingly, the seating surface of the seat back 272 can be adjusted more appropriately, and the occupant can get in and out more appropriately.

Incidentally, the measurement value of the degree of inclination of the vehicle V and the measurement value of the degree of inclination of the seat cushion 271 are computed by the computation unit 283.

As described above, when the vehicle V is in the “getting in/out mode”, the vehicle control device 280 controls the head drive device 273b to stow the headrest 273 on the seat back 272 side.

Accordingly, as the seat cushion 271 is raised by the height device 275, the unintended contact of the headrest 273 with the top wall portion 201c (roof portion 231) can be suppressed.

In addition, as shown in FIG. 20, the leg support member 279a is stowed instead of being deployed, so that, when the occupants stand up from the vehicle seats 260 and 270 or are seated therein, the contact of the calves of the occupants with the leg support members 2798 can be suppressed.

### Control of Rest Mode

When the mode of the vehicle V is the “rest mode, as shown in FIGS. 21 and 22, the operation control unit 282 controls the operation of the vehicle height adjustment device 210, the roof movement device 230, the head drive device 273b, the rail device 274, the height device 275, the tilt device 276, the reclining device 278, and the ottoman device 279.

Specifically, the operation control unit 282 controls the vehicle height adjustment device 210 to set the vehicle height to the “reference position”, and controls the roof movement device 230 to set the height of the roof portion 231 to the “reference position”.

In addition, the operation control unit 282 controls the head drive device 273b to set the height of the headrest 273 to a “reference position (deployed position)”, and controls the rail device 274 to set the front-to-rear position of the vehicle seat 270 to a “reference position”. In addition, the operation control unit 282 controls the height device 275 to set the height of the seat cushion 271 to the “reference position”, and controls the tilt device 276 to tilt the tilt posture of the seat cushion 271 rearward from the “reference position”. That is, the tilt device 276 is controlled to tilt the seating surface of the seat cushion 271 slightly rearward from the horizontal.

In addition, the operation control unit 282 controls the reclining device 278 to tilt the tilt posture of the seat back 272 rearward from the “reference position”. That is, the reclining device 278 is controlled to tilt the seating surface of the seat back 272 rearward. In addition, the operation control unit 282 controls the ottoman device 279 to set the leg support member 279a to the “deployed position”. That is, the ottoman device 279 is controlled to cause the leg support member 279a to protrude forward from the seat cushion 271.

As described above, the vehicle control device 280 controls the operation of each vehicle device, so that the occupant can be seated in the vehicle seat 270 in a relaxed manner. Particularly, when the vehicle V is in the “rest mode”, the height of the seat cushion 271, the tilt posture of the seat cushion 271 and the seat back 272, and the amount of protrusion of the leg support member 279a are controlled as described above, so that the occupants can be seated in the vehicle seats 260 and 270 more comfortably.

In the above-described configuration, in the vehicle V, the vehicle control device 280 controls the vehicle height adjustment device 210, the vehicle inclination measurement device 220, the roof movement device 230, the head drive device 273b, the rail device 274, the height device 275, the tilt device 276, the reclining device 278, and the ottoman device 279 in conjunction with each other in accordance with each mode of the vehicle V.

Accordingly, the occupant can get in and out of the vehicle V more appropriately, and the occupant can drive the vehicle V comfortably.

Incidentally, the vehicle control device 280 may control each vehicle device individually, in addition to controlling the vehicle devices in conjunction with each other.

In the above-described configuration, each vehicle device (drive device) has a sensing function that can transmit the state of a drive target, such as position and angle, to the vehicle control device 280. The vehicle control device 280 (the computation unit 283 and the communication unit 284) acquires the sensing information, and computes the position, angle, and the like of the drive target based on the sensing information. Then, the operation control unit 282 causes the vehicle body 201 (vehicle floor 250), the roof portion 231, the vehicle seats 260 and 270, and the like, which are drive targets, to operate.

Accordingly, the vehicle V can accurately operate the vehicle body 201 (vehicle floor 250), the roof portion 231, the vehicle seats 260 and 270, and the like in accordance with each mode.

### Vehicle Control Method

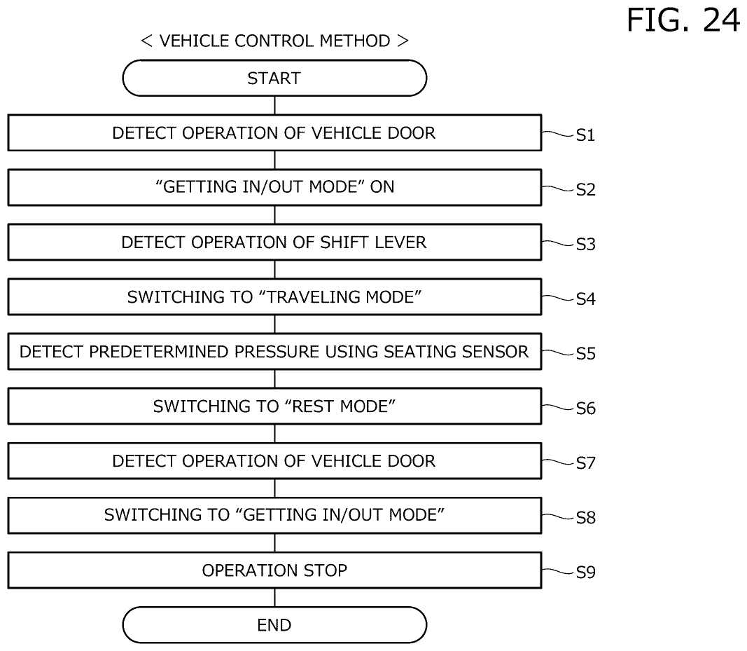

Next, the processing of a vehicle control program (vehicle control method) executed by the vehicle V will be described with reference to FIG. 24.

The program of the present embodiment is a program for realizing the operation control unit 282, the computation unit 283, and the communication unit 284 described above as the functional components of the vehicle control device 280 including the storage unit 281. The processor (CPU) of the vehicle control device 280 executes the vehicle control program.

The program is executed, for example, upon receiving a trigger such as an operation (operating a key switch) by the occupant (user) to start the program.

First, the vehicle control flow shown in FIG. 24 starts with step 1 (S1) in which the door opening and closing sensor of the vehicle door 203 detects that the vehicle door 203 has been opened or closed by the occupant.

When the door opening and closing sensor detects that the vehicle door 203 is opened, the door opening and closing sensor transmits a detection signal toward the vehicle control device 280 (operation control unit 282).

In step 2, the operation control unit 282 receives the detection signal from the door opening and closing sensor, and sets the mode of the vehicle V to the “getting in/out mode”.

In this case, when the mode of the vehicle V is the “stop mode (reference mode) ”, the operation control unit 282 performs control to switch the mode of the vehicle V from the “stop mode” to the “getting in/out mode”.

In step 3, a shift sensor of the shift lever 204 detects that the shift lever 204 is set to drive by the occupant. When the shift sensor detects the operation of the shift lever 204, the shift sensor transmits a detection signal toward the operation control unit 282.

Then, in step 4, the operation control unit 282 receives the detection signal from the shift sensor of the shift lever 204, and switches the mode of the vehicle V from the “getting in/out mode” to the “traveling mode”.

In step 5, the seating sensors 244 and 245 of the vehicle seat 270 detect the predetermined seating pressure (pressure), and transmit detection signals toward the operation control unit 282.

For example, the seating sensor 45 of the seat back 272 detects that the seating pressure has increased to the predetermined pressure within the predetermined time, and the seating sensor 244 of the seat cushion 271 detects that the seating pressure has decreased to the predetermined pressure within the predetermined time.

Then, in step 6, the operation control unit 282 receives the detection signals from the seating sensors 244 and 245, and switches the mode of the vehicle V from the “traveling mode” to the “rest mode”.

In step 7, the door opening and closing sensor of the vehicle door 203 detects that the vehicle door 203 has been opened or closed by the occupant.

Specifically, when the door opening and closing sensor detects that the vehicle door 203 is opened, the door opening and closing sensor transmits a detection signal toward the operation control unit 282.

Then, in step 8, the operation control unit 282 receives the detection signal from the door opening and closing sensor, and switches the mode of the vehicle V from the “rest mode” to the “getting in/out mode”.

Then, when a command for the operation stop of the program is received (step 9), the process shown in FIG. 24 is ended. On the other hand, when a command for the operation stop is not received, the process returns to step 1 as appropriate and is repeated.

Incidentally, the mode switching of the vehicle V and the start condition and the switching condition for each mode in the program are merely examples, and can be changed as appropriate. The vehicle control device 280 may switch the mode of the vehicle V from the “getting in/out mode” to the “rest mode” or from the “rest mode” to the “traveling mode”. In addition, the vehicle control device 280 may switch the mode of the vehicle V simply when the occupant operates the mode switching operation switch.

According to the vehicle and the vehicle control method described above, the occupant can get in and out appropriately, and can drive the vehicle comfortably. Particularly, the mode of the vehicle is switchable in accordance with an operation or action by the occupant, and the ride comfort of the occupant can be ensured.

### Others

In the above-described embodiment, the vehicle control device 280 controls the vehicle height adjustment device 210, the vehicle inclination measurement device 220, the roof movement device 230, the head drive device 273b, the rail device 274, the height device 275, the tilt device 276, the reclining device 278, and the ottoman device 279; however, the present invention may not be particularly limited.

For example, the vehicle V (vehicle control device 280) may control at least the vehicle height adjustment device 210, the height device 275, and the tilt device 276 in accordance with the mode of the vehicle V. Incidentally, it is preferable that the vehicle control device 280 performs control as follows.

When the vehicle V is in the “traveling mode” shown in FIG. 18, it is preferable that the seat back 272 is tilted rearward and the seating surface of the seat back 272 is tilted rearward by approximately 10 to 30 degrees, preferably 20 degrees, with respect to a vertical plane. Incidentally, the positions of the seat cushion 271, the seat back 272, and the headrest 273 in the “traveling mode” are also referred to as the “reference positions”.

When the vehicle V is in the “getting in/out mode” shown in FIG. 20, it is preferable that the seat cushion 271 is tilted forward and the seating surface of the seat cushion 271 is tilted forward by approximately 15 to 35 degrees (preferably 25 degrees) with respect to a horizontal plane. In addition, it is preferable that the seat back 272 is slightly tilted rearward and the seating surface of the seat back 272 is aligned along a vertical plane or is slightly tilted rearward with respect to the vertical plane.

### Supplementary Note 2

The above-described problem is solved by a vehicle of the present invention, the vehicle including: a vehicle height adjustment device that adjusts a height of the vehicle; a vehicle seat installed inside the vehicle and attached to a vehicle floor; and a vehicle control device that performs control to switch the vehicle between a first mode and a second mode different from the first mode. The vehicle seat includes a seat cushion, a height device that adjusts a height of the seat cushion, and a tilt device that tilts at least a part of the seat cushion forward. When the vehicle is in the second mode, the vehicle control device controls the vehicle height adjustment device to lower the height of the vehicle compared to when in the first mode, controls the height device to raise the height of the seat cushion compared to when in the first mode, and controls the tilt device to tilt at least a part of the seat cushion forward compared to when in the first mode.

With the above-described configuration, a vehicle that allows an occupant to get in and out appropriately and to drive the vehicle can be realized.

In detail, the vehicle is switchable between the “first mode (for example, a traveling mode) ” and the “second mode (for example, a getting in/out mode) ”, and the vehicle can be controlled to lower the height of the vehicle, to raise the height of the seat cushion, and to tilt at least a part of the seat cushion forward when in the “second mode” compared to when in the “first mode”. As a result, when the vehicle is in the “second mode”, the occupant can get in and out of the vehicle appropriately. Incidentally, when the vehicle is in the “first mode”, the occupant can drive the vehicle.

Specifically, when the occupant gets in and out of the vehicle, it is preferable that the distance between the ground and the vehicle floor in an up to down direction (vehicle height) is reduced as much as possible and the distance between the vehicle floor and the seat cushion in the up to down direction is set to be relatively large. Furthermore, it is preferable that at least a part of the seat cushion is slightly tilted forward (ensuring the ease of getting in and out). In addition, during traveling of the vehicle, it is preferable that the distance between the traveling surface of the vehicle and the vehicle floor in the up to down direction is set to be relatively large and the distance between the vehicle floor and the seat cushion in the up to down direction is set to be relatively small (ensuring ride comfort during traveling). The height of the vehicle floor (vehicle height), the height of the seat cushion, and the posture can be satisfactorily adjusted by the mode switching.

In this case, it is preferable that the second mode is a getting in/out mode for allowing an occupant to get in and out. It is preferable that, when in the getting in/out mode, the vehicle control device controls the tilt device to tilt a seating surface of the seat cushion forward with respect to a floor surface of the vehicle floor.

In addition, it is preferable that the second mode is a getting in/out mode for allowing an occupant to get in and out. It is preferable that the vehicle further includes a vehicle inclination measurement device that measures a degree of inclination of the vehicle with respect to a traveling surface on which the vehicle travels and a seat inclination measurement device that measures a degree of inclination of the seat cushion with respect to the vehicle floor. It is preferable that, when in the getting in/out mode, the vehicle control device controls the tilt device to tilt a seating surface of the seat cushion forward with respect to the traveling surface based on the degree of inclination of the vehicle and the degree of inclination of the seat cushion.

With the above-described configuration, when the occupant gets in and out of the vehicle, the seating surface of the seat cushion can be tilted forward, and the occupant can get in and out more appropriately.

In this case, it is preferable that the second mode is a getting in/out mode for allowing an occupant to get in and out. It is preferable that the vehicle seat includes a rail device including a lower rail fixed to the vehicle floor and an upper rail that is slidably connected to the lower rail. It is preferable that, when in the getting in/out mode, the vehicle control device controls the tilt device to tilt a seating surface of the seat cushion forward with respect to an upper surface of the upper rail.

With the above-described configuration, when the occupant gets in and out of the vehicle, the seating surface of the seat cushion can be tilted forward, and the occupant can get in and out more appropriately.

In this case, it is preferable that the vehicle seat includes a seat back and a reclining device that rotatably connects the seat back to the seat cushion and that locks the seat back. It is preferable that the vehicle control device controls the reclining device to tilt the seat back rearward with respect to the seat cushion when in the second mode compared to when in the first mode.

In addition, it is preferable that, when in the second mode, the vehicle control device controls the reclining device to set a seating surface of the seat back to be perpendicular to a floor surface of the vehicle floor.

In addition, it is preferable that, when in the second mode, the vehicle control device controls the reclining device to set a seating surface of the seat back to be vertical.

With the above-described configuration, when the occupant gets in and out of the vehicle, the seat cushion is set to a forward tilt posture (slightly forward tilt posture) and the seat back is set to a rearward tilt posture (slightly rearward tilt posture), so that the occupant can get in and out of the vehicle appropriately. Incidentally, when the seat back is set to the forward tilt posture, the back of the occupant is pressed by the seat back when getting in and out.

In this case, it is preferable that, when in the second mode, the vehicle control device controls the vehicle height adjustment device, the height device, and the tilt device in conjunction with each other.

In addition, it is preferable that, when in the second mode, the vehicle control device controls the vehicle height adjustment device, the height device, the tilt device, and the reclining device in conjunction with each other.

With the above-described configuration, the occupant can get in and out of the vehicle more appropriately, and the occupant can drive the vehicle comfortably.

In this case, it is preferable that the first mode is a traveling mode for allowing the vehicle to travel and the second mode is a getting in/out mode for allowing an occupant to get in and out. It is preferable that the vehicle control device performs control to switch the vehicle between the traveling mode, the getting in/out mode, and a third mode different from the traveling mode and the getting in/out mode.

In addition, it is preferable that the third mode is a rest mode for allowing the occupant to relax in a state where the occupant is seated in the vehicle seat. It is preferable that, when in the rest mode, the vehicle control device controls the tilt device using operation control different from operation control when in the traveling mode and the getting in/out mode.

With the above-described configuration, the vehicle control device can perform control to switch the mode of the vehicle between the “traveling mode”, the “getting in/out mode”, and the “rest mode” in accordance with an operation or action by the occupant.

In this case, it is preferable that the vehicle control device includes a storage unit that stores mode activation information including a mode start condition and/or a mode switching condition for each of the traveling mode, the getting in/out mode, and the rest mode. It is preferable that the vehicle control device controls the vehicle to start in a predetermined mode and controls the vehicle to switch to the predetermined mode, based on mode activation information.

With the above-described configuration, the mode of the vehicle is switchable more appropriately based on the mode activation information. Accordingly, the occupant can get in and out of the vehicle more appropriately, and the occupant can drive the vehicle conveniently.

In the above-described embodiment, the vehicle seat used in automobiles has been described as a specific example; however, the present invention is particularly limited, and can be used for various seats such as office chairs for work, wheelchairs, and child chairs for shopping carts in addition to two-wheeled seats for two-wheeled vehicles, vehicle seats for trains, buses, or the like, and conveyance seats for airplanes, ships, or the like.

In the present embodiment, the vehicle seat according to the present invention has been mainly described.

However, the above-described embodiment is merely one example to facilitate understanding of the present invention, and does not limit the present invention. The present invention can be modified and improved without departing from the concept of the present invention, and it goes without saying that the present invention includes its equivalents.

### REFERENCE SIGNS LIST

S1: vehicle seat
F: seat frame (frame)
Fa: back frame
Fb: cushion frame
T: skin
Ta: skin material
Tb: cushion layer
P: pad material
P1: back pad
P2: cushion pad
1: seat back
2: seat cushion
3: headrest
4: airbag device
10: engaging member
11: engaging portion
   11a base portion
   11b: hook
12: engaged portion
   12a: extending portion
   12b: pad separation suppression portion
   12c: through-hole
20: locking member
21: locking portion
   21a: proximal end portion
   21b: distal end portion
22: locked portion
   22a: base portion
   22b: holding portion
30, 40, 50, 60, 70, 80: groove portion
   30a: first groove portion
   30b: second groove portion
   30c: third groove portion
   30d: fourth groove portion
   30e: fifth groove portion
   30f: sixth groove portion
31, 51, 61, 71, 81: attachment portion
   71a: first attachment portion
   71b: second attachment portion
32, 52, 62, 72, 82: attachment surface
   32a, 52a, 62a, 72a, 82a: first attachment surface
   32b, 52b, 62b, 72b, 82b: second attachment surface
   62c: third attachment surface
41: engaging portion
   41a base portion
   41b: hook
73, 83: non-attachment surface
S2: vehicle seat
F: seat frame (frame)
   Fa: back frame
   Fb: cushion frame
P: pad material
   Pa: pad main body
      Pa1: blowing port
   Pb: passage forming portion
   Pc: sensor attachment portion
   Pd: groove portion
C: corner portion
T: skin (vehicle interior skin)
ST: thread
R: rubber member
101: seat back
102: seat cushion
103: headrest
104: airbag device
   104a: tear line
105: detection unit
106: notification unit
   106a: vibration unit
   106b: side vibration unit
107: blower device
   107a: blower main body
   107b: duct
108: temperature adjustment unit
109: seat movement unit
110: engaging member
111: engaging portion
112: engaged portion
120: skin material
   120a: skin material back surface (surface on pad material side)
130: cushion layer
131: stretch layer
   131a: stretch layer back surface (surface on pad material side)
132: nonwoven fabric
140: air passage portion
V: vehicle
201: vehicle body
   201a: bottom wall portion
   201b: side wall portion
   201c: top wall portion
   201d: front wall portion
   201e: rear wall portion
202: wheel
203: vehicle door
   203a: door handle
204: shift lever
210: vehicle height adjustment device (suspension device)
215: distance sensor
220: vehicle inclination measurement device
230: roof movement device
231: roof portion
232: connecting link
240: onboard sensor
241: imaging device
242: LiDAR
243: gyro sensor
244, 245: seating sensor
250: vehicle floor
260: vehicle seat (front seat)
270: vehicle seat (rear seat)
271: seat cushion
   271a: cushion frame
   271b: side frame
   271c: pan frame
   271d: rear connecting frame
272: seat back
   272a: back frame
273: headrest
   273a: head pillar
   273b: head drive device
274: rail device
   274a: lower rail
   274b: upper rail
275: height device
276: tilt device
277: seat inclination measurement device
278: reclining device
   278a: reclining main body
279: ottoman device
   279a: leg support member
280: vehicle control device
281: storage unit
282: operation control unit
283: computation unit
284: communication unit

1. A vehicle seat, comprising:
a frame;
a pad material disposed on the frame;
a skin covering the pad material; and
an engaging member that pulls the skin into the pad material,
wherein the engaging member is a hook-and-loop fastener, and includes an engaging portion provided on the skin, and an engaged portion provided on the pad material and engaged with the engaging portion,
a long groove portion for pulling in the skin is formed in the pad material,
an attachment surface for attaching the engaged portion is formed on a bottom surface of the groove portion, and
at least a part of the attachment surface is inclined with respect to a perpendicular plane perpendicular to a depth direction of the groove portion.

2. The vehicle seat according to claim 1,
wherein the attachment surface is inclined from one side toward an other side in a longitudinal direction of the groove portion.

3. The vehicle seat according to claim 2,
wherein the attachment surface is inclined to be symmetric about a center portion of the groove portion in the longitudinal direction.

4. The vehicle seat according to claim 3,
wherein the attachment surface is inclined such that the groove portion is deeper at both end portions of the groove portion in the longitudinal direction than at the center portion of the groove portion.

5. The vehicle seat according to claim 3,
wherein the attachment surface is inclined such that the groove portion is deeper at the center portion of the groove portion in the longitudinal direction than at both end portions of the groove portion.

6. The vehicle seat according to claim 2,
wherein the attachment surface has a first attachment surface provided on the one side in the longitudinal direction of the groove portion, a second attachment surface provided on the other side in the longitudinal direction of the groove portion, and a third attachment surface provided between the first attachment surface and the second attachment surface in the longitudinal direction of the groove portion,
each of the first attachment surface and the second attachment surface is inclined with respect to the perpendicular plane, and
the third attachment surface is provided to be parallel to the perpendicular plane.

7. The vehicle seat according to claim 1, further comprising:
an airbag device attached to the frame and including an airbag and an inflator; and
a locking member that is a member different from the engaging member and that is used for pulling the skin into the pad material,
wherein the locking member is a member other than a hook-and-loop fastener, and includes a locking portion provided on the skin, and a locked portion provided on the pad material and locked to the locking portion,
the groove portion includes a first groove portion formed at a position corresponding to the airbag device, and a second groove portion formed at a position different from the position of the first groove portion,
the locked portion of the locking member is provided in the first groove portion, and
the engaged portion of the engaging member is provided in the second groove portion.

8. The vehicle seat according to claim 7,
wherein the locking portion of the locking member is a hook, and
the locked portion of the locking member is a clip that is hooked onto the hook.

9. The vehicle seat according to claim 2,
wherein the engaged portion includes an extending portion engaged with the engaging portion and extending along the longitudinal direction of the groove portion, and pad separation suppression portions that are provided at both end portions of the extending portion in a width direction and that suppress a separation of the engaged portion from the pad material.

10. The vehicle seat according to claim 9,
wherein a through-hole penetrating through each of the pad separation suppression portions in a perpendicular direction perpendicular to an extending direction and the width direction of the extending portion is formed in the pad separation suppression portion.

11. The vehicle seat according to claim 10,
wherein the through-hole has a triangular shape when viewed in the perpendicular direction of the extending portion.
